(19) United States
(12) Patent Application Publication
(10) Pub. No.: US 2015/0104759 A1
(43) Pub. Date: Apr. 16, 2015

(54) METHOD AND SYSTEM FOR TAKING A SURVEY WITH IMPROVED ACCURACY AND EFFECTIVENESS

(71) Applicants: Torin J. BLOCK, Oakland, CA (US); Gladys M. BLOCK, Berkeley, CA (US); Clifford H. BLOCK, Berkeley, CA (US)

(72) Inventors: Torin J. BLOCK, Oakland, CA (US); Gladys M. BLOCK, Berkeley, CA (US); Clifford H. BLOCK, Berkeley, CA (US)

(21) Appl. No.: 14/494,434

(22) Filed: Sep. 23, 2014

Related U.S. Application Data
(60) Provisional application No. 61/881,087, filed on Sep. 23, 2013.

(51) Int. Cl. G09B 19/00; G09B 7/08

(52) U.S. Cl. CPC G09B 19/0092; G09B 7/08
USPC 434/127; 434/236; 700/91

(57) ABSTRACT

A computer-implemented method of generating questions for a survey is presented. The method entails receiving user input regarding a relevant characteristic in response to a first question, and using the user input and a default item to determine items to be included in the second question, wherein the items are associated with the relevant characteristic and are in a same item group as the default item. The items may be food, and the relevant characteristic may indicate the types of food that may be eaten or be avoided. Also presented is a computer-implemented method of changing a user's behavior. The method entails assigning a user to a team, and allowing the user to earn points for the team by making changes to one's diet and/or activities.

### RELATED APPLICATION

This application claims priority to U.S. Provisional Patent Application No. 61/881,087 filed on Sep. 23, 2013, the content of which is incorporated by reference herein.

### FIELD OF INVENTION

The present disclosure relates generally to a system and method for changing people's behaviors, including behaviors pertaining to diet and activity.

### BACKGROUND

Computer-based questionnaires are used for many purposes, such as taking a survey or obtaining feedback on a service. The answers to the computer-based questionnaires are then used to calculate scores that translate to useful information. How helpful the resulting information is depends largely on the accuracy of the answers that were received.

Generally, a challenge to extracting the most benefit out of questionnaires is motivating the participant to accurately answer the questions. Often, some type of reward is offered for completing a questionnaire or taking a survey, obviously to interest more participants; however, such rewards do not guarantee of even increase the likelihood that the participant will make an effort to provide accurate answers or to stay interested throughout the duration of the survey.

A system and method that will increase participant interest and enhance a participant's engagement with a questionnaire is desired.

### SUMMARY

In one aspect, the disclosure pertains to a computer-implemented method of generating questions for a survey. The method entails receiving user input regarding a relevant characteristic in response to a first question, and using the user input and a default item to determine items to be included in the second question, wherein the items are associated with the relevant characteristic and are in a same item group as the default item. The items may be food, and the relevant characteristic may indicate the types of food that may be eaten or be avoided.

In another aspect, the disclosure pertains to a computer-implemented method of changing a user's behavior. In one implementation, the method may entail assigning a user to a team, and allowing the user to earn points for the team by making changes to one's diet and/or activities. In other implementations, the user may earn points for himself.

In yet another aspect, the disclosure pertains to a computer-implemented method of changing a user's behavior by: receiving responses to questions regarding a user's eating habits and physical activity level, generating a recommendation to change the user's diet and/or physical activity level based on a goal, rewarding points in response to either an indication that the recommended change has been made or by taking a quiz about nutrition and health, and allowing points to be redeemed for one of actual currency and lottery/raffle tickets.

### BRIEF DESCRIPTION OF THE DRAWINGS

FIG. 1 depicts a flowchart for an implementation of the Question Varying process in accordance with an embodiment of the inventive concept.

FIG. 2A and FIG. 2B depicts an implementation of Questionnaire Simplification Tool in accordance with an embodiment of the inventive concept.

FIG. 3 depicts an embodiment of Questionnaire Simplification Tool in accordance with an embodiment of the inventive concept.

FIG. 4 depicts the Action Plan generation process whereby a base Action Plan is generated.

FIG. 5 depicts one embodiment of the Sidebar Running Total tool pertaining to one type of food.

FIG. 6 depicts a flowchart of the Sidebar Running Total calculation process.

FIG. 7 depicts a screenshot of the Interstitial Summaries Tool in accordance with one embodiment of the inventive concept.

FIG. 8 depicts a flow chart of the Interstitial Summaries generation process in accordance with an embodiment of the inventive concept

FIG. 9 and FIG. 10 depict screenshots of the Review Button Tool in accordance with one embodiment of the inventive concept.

FIG. 11 depicts a flowchart of the Review Button process in accordance with one embodiment of the inventive concept.

FIG. 12 depicts a flow chart of the Review-by-Sorting process in accordance with one embodiment of the inventive concept.

FIG. 13 depicts a flowchart of the Most Frequently Used item Selector process in accordance with one embodiment of the inventive concept.

FIG. 14 depicts a flowchart of the Activity Plan process in accordance with one embodiment of the inventive concept.

FIG. 15 depicts a screen shot of one question in a questionnaire about baseline activity level in accordance with one embodiment of the inventive concept.

FIG. 16 depicts an example of what may be presented to the user in accordance with one embodiment of the inventive concept.

FIG. 17 depicts an example of the format by which all aspects of the activity plan can be changed by the participant, in accordance with one embodiment of the inventive concept.

FIG. 18 depicts a flowchart of the Personal Support Team process in accordance with one embodiment of the inventive concept.

FIG. 19 depicts an example of invitation to support participant, in accordance with one embodiment of the inventive concept.

FIG. 20 depicts an invitation to join support team, in accordance with one embodiment of the inventive concept.

FIG. 21 depicts a reminder to a member of participant's support group, in accordance with one embodiment of the inventive concept.

FIG. 22 depicts an example of a user interface that may help the friend/family create their supportive message, in accordance with one embodiment of the inventive concept.

FIG. 23 depicts a user interface that allows a participant to share the health information from the Behavior Change Intervention with others, in accordance with one embodiment of the inventive concept.

FIG. 24 depicts a flowchart of the Prevention Points process in accordance with one embodiment of the inventive concept.

FIG. 25 depicts a flowchart of the Virtual Support Messaging process in accordance with one embodiment of the inventive concept.

FIG. 26 depicts a message that may be sent to a team, in accordance with one embodiment of the inventive concept.

FIG. 27 depicts a flowchart of the Automated Coaching process in accordance with one embodiment of the inventive concept.

FIG. 28, FIG. 29, and FIG. 30 depict various screen shots in accordance with one implementation of the Automated Coaching process.

FIG. 31 depicts a flowchart of the functioning of one embodiment of this Real-time Reminder process in accordance with one embodiment of the inventive concept.

### DETAILED DESCRIPTION

Although the inventive concepts herein are presented in the context of a dietary questionnaire, this is not a limitation and the concepts may be adapted to other types of questionnaires. As used herein, “participant” or “respondent” refers to someone providing responses to questions.

The inventive concept disclosed herein includes a set of components to enhance the user experience and accuracy during data collection, and to help participants in an online or electronic behavior change program to achieve behavior changes successfully. As participants are completing an online or electronic behavior-change program, it is essential for their success that they continue to interact with the program over time, and receive support and information, both from the program itself and from external sources. The inventive concept disclosed herein strives to achieve these goals.

As questionnaires are being completed by participants, motivation may lag or participants may not realize that their answers will result in a hard mathematical calculation. For example, diet questionnaires often ask respondents about a long list of foods, sometimes as many as 150 food items. For the accuracy of the eventual nutrient estimate, it matters that participants realize that their answers are being used for calculations and that care in responding is important. Seeing interim calculations may stimulate continuing interest and be educational to the participant.

The processes disclosed herein may use one or more of the following components or software modules:
a) Survey questions are modified to be specific to participant characteristics (“Question Varying Tool”)
b) Question display is simplified for clarity (“Question Simplification Tool”)
c) Calculations and displays occur in real time, as each question is answered (“Sidebar Running Total Tool”)
d) Calculations and displays occur at other points as the questionnaire is being answered (“Interstitial Summaries Tool”)
e) Responses and calculations can be revised by the user prior to final submission of the set of answers (“Review Button Tool”)
f) Responses and calculations can be revised through a sort and re-sort system
g) The user can select sub-items within a several-item question
h) The user can create and revise a physical activity scheduler (“Activity Plan Tool”)
i) The user is assisted in engaging the social support of persons outside the behavior change program, in the real world (“Personal Support Team Tool”)
j) The user motivation to participate via a points system that can be either converted to money or lottery/raffle tickets for the individual or for a donation to charity (“Prevention Points Tool”)
k) The user is assisted in sending and receiving support from a team through a messaging system (“Virtual Support Team Messaging Tool”)
l) The user is supported in achieving goals through coaching about problems and barriers (“Automated Coaching Tool”)
m) The user is supported in achieving goals through a reminder system (“Real-time Reminder Tool”)

The inventive concepts are described below, for simplicity, in the general context of usage in a desktop computer environment. However, the concepts disclosed herein are adaptable to other environments such as tablets, smart devices, mobile devices, verbal responses, gestures, etc. Similarly, although the descriptions below may refer to databases or spreadsheets, these are just exemplary embodiments and other ways of storing, organizing, and retrieving data may be used.

### Question Varying Tool

The Question Varying Tool modifies the wording of survey questions “on the fly,” or as the participant is answering the questions. For example, the fifth question may be worded differently depending on the participant's answer to the third or fourth question. The wording of the fifth question may be modified to be more specific to the particular participant's characteristics. This is different from a conventional questionnaire, which ordinarily consists of a list of pre-written questions. Systems may exist whereby entire questions are added or omitted depending on participant's answer to previous questions, such as presenting questions about pregnancy only if the participant has previously indicated that she is female. The system and process described herein differs from such question-by-question modification in that the list of questions remains unchanged and just the wording within a question may be varied depending on previous responses.

Generally, the Question Varying Tool receives a relevant characteristic as a user input, and uses the relevant characteristic to find items that should be included along with the default item in the default version of the question. For example, in a case where a diet questionnaire asks how often the respondent eats bread, “bread” would be the default item. For nutritional analysis, it would be desirable to capture not just slices of bread but also other bread-type foods or foods that are nutritionally similar to bread that may be eaten by different ethnic groups (in this case, ethnic group would be a relevant characteristic as an indicator of the type of food eaten). With the Question Varying Tool, the question may be presented to the respondent in different forms depending on other characteristics, such as race, religion, or ethnicity. Depending on how the ethnicity question was answered, the question may be presented as “How often do you eat bread or tortillas?” or “How often do you eat bread, roti or naan?” If the question is presented in a generic or default form, which may be “How often do you eat bread?” there is room for miscommunication because the participant might interpret the word “bread” to only mean a certain type of wheat-based baked food. If there is miscommunication, the answer will not accurately reflect the nutritional intake of the participant because someone who eats a lot of naan may provide a low number as an answer to the default question about “bread,” believing that the question does not pertain to his naan intake.

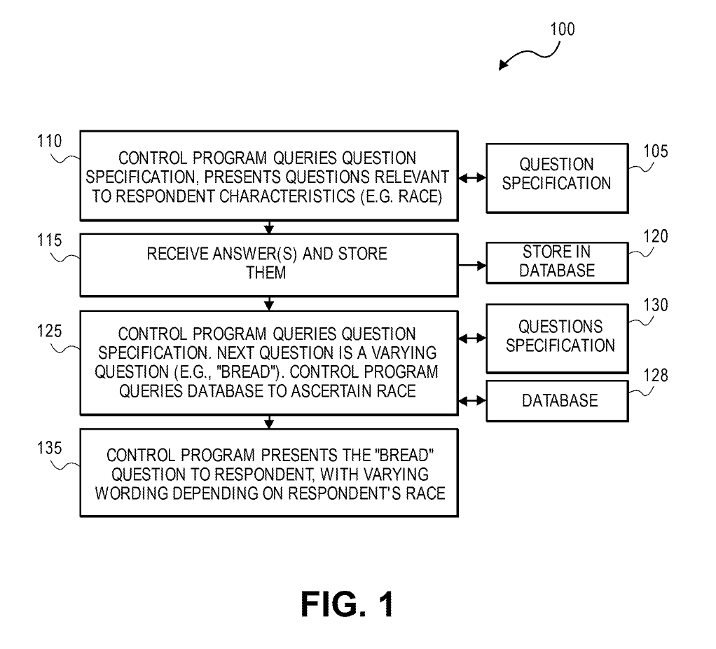

FIG. 1 depicts a flowchart for an example implementation of the Question Varying process 100. A participant begins an electronic questionnaire, for example in a web browser or other electronic display device such as a mobile device or a smartphone/smartwatch. The program has access to a Question Specification document that contains the questions to be asked, conditions under which each question is to be asked, and specifications for questions whose wording may vary depending on previous responses. Accessing the Question Specification document (105), the program presents to the respondent any questions that determine relevant respondent characteristics, such as race or ethnicity (110). The response is received (115) and stored (120), for example in a database, cloud, or memory. The program presents questions as specified in the Question Specification document (125). The program queries the database (128) to determine race, then looks at the Questions Specification document (130) to determine the right wording for that race. A modified question with wording specific for the given race is presented (135), worded appropriately according to the specifications, to solicit information about nutritionally-similar food items.

The Question Varying Process 100 may be adapted to physical activity. For example, a participant may provide questions about his age or gender, and the types of activities he enjoys. Based on the answers provided, the next question may be rephrased to include activities that are more likely to be engaged in by the participant. For example, a default question like “how often do you run?” may be modified as “how often do you run, speed walk, or hike?” if hiking and speed-walking were mentioned as preferred activities in previous responses and running, speed-walking, and hiking are similar activities in terms of a predefined metric such as intensity level, energy cost (e.g., metabolic equivalent), cardiovascular benefits, etc.

An example of a portion of Question Specification may be as follows:

```
      <screen title=“Bread” feedback=”nutrition”>
      <header>How often do you eat bread<if latino=”1”>,
tortillas</if><if Asian=”true”asianType=”1”., rota, or naan</if>.
</header>
      <multichoice ref=”breadbagelsFreq”>
        <html><![CDATA[<span style=”color:#006699;”>How many
days per week?</span>]]><html>
        <br/>
        <choice value=”1” skin=”n_howoften1”>Less than once a
        week</choice>
        <choice value=”2” skin=”n_howoften2”>1 day</choice>
        <choice value=”3” skin=”n_howoften3”>2 days</choice>
        <choice value=”4” skin=”n_howoften4”>3-4 days</choice>
        <choice value=”5” skin=”n_howoften5”>5-6 days</choice>
        <choice value=”6” skin=”n_howoften6”>every day</choice>
      </multichoice>
```

### Question Simplification Tool

The Question Simplification Tool presents the respondent with a series of questions in a way that maximizes the intuitiveness of the manner of response, minimizes the amount of text that the respondent must read, and minimizes the number of clicks required from the respondent. Diet questionnaires, such as food frequency questionnaires, ask the respondent about a long list of foods. And questionnaires may ask about several aspects of the respondent's consumption of a food. These aspects often include frequency of consumption (“how often do you eat ______”), amount of consumption (“how much do you eat each time”), and type or variety of a food (“what kind of milk do you usually drink”). Questionnaires are often presented to the respondent with more than one food on a screen, and often with multiple aspects of the question on the same screen. This can produce visual and cognitive overload, resulting in a negative feeling about the questionnaire, reluctance to complete it or inaccuracies in response.

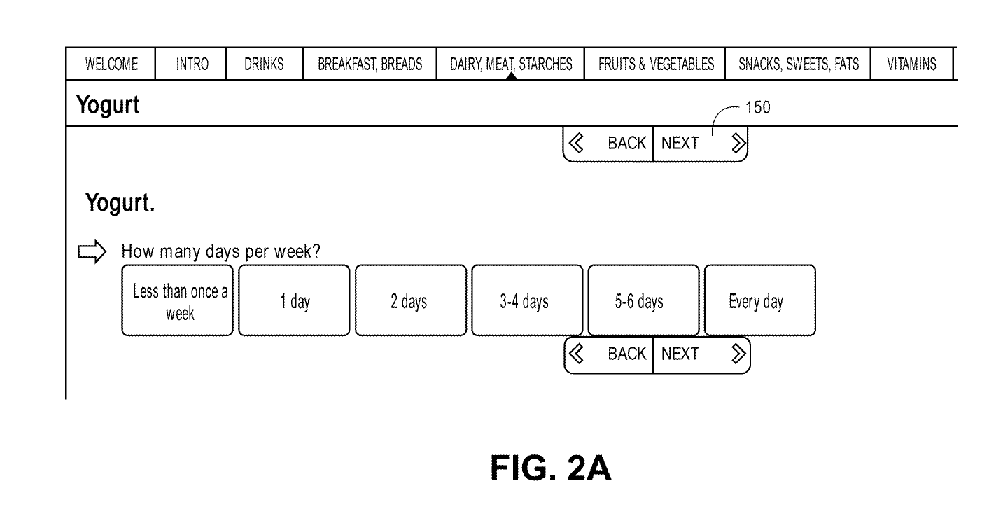

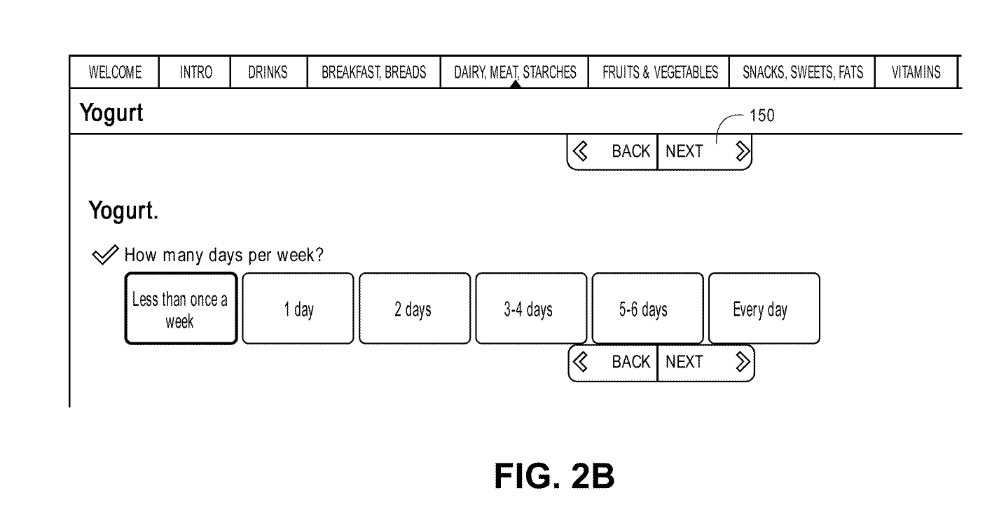

The Questionnaire Simplification Tool simplifies diet questionnaire presentation and interaction in several ways. First, the Question Specification document may present the questions with only a single food on a screen at a time. FIG. 2A is an example implementation of Questionnaire Simplification Tool. As shown in FIG. 2A, only a single food (Yogurt, in this case) is shown on the screen at a time, with one question. In the screenshot of FIG. 2A, the question pertains to the respondent's frequency of consumption. If the respondent eats it less than once a week, as shown in FIG. 2B, no further questions about that food are needed, and the Next button 150 becomes live (as shown in FIG. 2B). The answer system is simple, intuitive, and fast.

Another way in which the questionnaire user interaction is simplified is in the nature of the response buttons. In a lot of systems, buttons are shown next to the description of the response category (e.g., “∘ 2 days” or “∘ 3 days”). In the Questionnaire Simplification Tool system, the words of the response category are themselves clickable (FIGS. 2A and 2B). Again, the method of interacting with the answer set is more intuitive. The size, shape, and color of the boxes showing the response category are specified in the Question Specification document. In some embodiments, the color of the boxes may become progressively more saturated as the value of the frequency response buttons increases, providing a visual cue to the respondent. An example of Question Specification document section for Questionnaire Simplification Tool is as follows:

```
      <screen title=”Yogurt” feedback=”nutrition”>
      <header>Yogurt<if asian=”true” asianType=”1”>or lassi</if>.</header>
      <multichoice ref=”yogurtFreq”>
        <html><![CDATA[<span style=”color:#006699;”>How many days per
week?</span>]]></html>
      <br/>
        <choice value=”1” skin=”n_howoften1”>Less than once a week</choice>
        <choice value=”2” skin=”n_howoften2”>1 day</choice>
        <choice value=”3” skin=”n_howoften3”>2 days</choice>
        <choice value=”4” skin=”n_howoften4”>3-4 days</choice>
        <choice value=”5” skin=”n_howoften5”>5-6 days</choice>
        <choice value=”6” skin=”n_howoften6”>every day</choice>
      </multichoice>
      <if yogurtFreq=”2, 3, 4, 5, 6”>
      <multichoice ref=”yogurtQuan”>
      ,html><![CDATA[<span style=”color: #006699;”>How much</span>on those
days?]]><html>
      <br/>
        <choice value=”1” skin=”n_howoften1”>Small, ½ cup</choice>
        <choice value=”2” skin=”n_howoften2”>Medium, 1 cup</choice>
        <choice value=”3” skin=”n_howoften3”>Large, more than 1 cup</choice>
      </multichoice>
      <multichoice ref+’yogurtType”>
      <html><!CDATA[<span style=”color: #006699;”>What kind</span>,
usually?]]></html>
      <br/>
      <choice value=”1”skin=”n_whatkind1”>Yogurt<if Asian=”true” asianType=”1”>or
lassi</if>, sweetened</choice>
      <choice value=”2” dkin=”n_whatkind2”>Yogurt<if Asian=”true” asianType=”1”> or
lassi</if>, plain unsweetened</choice>
      </multichoice>
      </if>
      </screen>
      <skins>
      <skin name=”n_howoften1” parents=”default”
      minWidth=”100”
      minHeight=”60”
/>
      <skin name=”n_howoften2” parents=”default”
      minWidth=”100”
      minHeight=”60”
<skin name=”n_howoften3” parents=”default”
      minWidth=”100”
      minHeight=”60”
/>
<skin name=”n_howoften4” parents=”default”
      minWidth=”100”
      minHeight=”60”
/>
<skin name=”n_howoften5” parents=”default”
      minWidth=”100”
      minHeight=”60”
/>
<skin name=”n_howoften6” parents=”default”
      minWidth=”100”
      minHeight=”60”
/>
<skin name=”n_howmuch1” parents=”default”
      minWidth=”100”
      minHeight=”60”
/>
<skin name=”n_howmuch2” parents=”default”
      minWidth=”100”
      minHeight=”60”
<skin name=”n_howmuch3” parents=”default”
      minWidth=”100”
      minHeight=”60”
<skin name=”n_howmuch4” parents=”default”
      minWidth=”100”
      minHeight=”60”
/>
<skin name=”n_whatkind1” parents=”default”
      minWidth=”100”
      minHeight=”60”
/>
<skin name=”n_whatkind2” parents=”default”
      minWidth=”100”
      minHeight=”60”
/>
<skin name=”n_whatkind3” parents=”default”
      minWidth=”100”
      minHeight=”60”
/>
</skins>
<defaults
multichoiceChoiceMinHeight=”60”
multichoiceChoiceMinWidth=”100”
multichoiceChoiceColorUnselectedUnpressedStart=”#ffffff”
multichoiceChoiceColorUnselectedUnpressedFinish=”#C7E0F0”
multichoiceChoiceColorUnselectedOverStart=”#ffffff”
multichoiceChoiceColorUnselectedOverFinish=”#ECF4FA”
multichoiceChoiceColorUnselectedPressedStart=”#ffffff”
multichoiceChoiceColorUnselectedPressedFinish=”#ECF4FA”
multichoiceChoiceColorSelectedUnpressedStart=”#96dff4”
multichoiceChoiceColorSelectedUnpressedFinish=”#269cdc”
multichoiceChoiceColorSelectedOverStart=”#96dff4”
multichoiceChoiceColorSelectedOverFinish=”#269cdc”
multichoiceChoiceColorSelectedPressedStart=”#96dff4”
multichoiceChoiceColorSelectedPressedFinish=”#269cdc”
>
<footer><![CDATA[ ]]></footer>
</defaults>
```

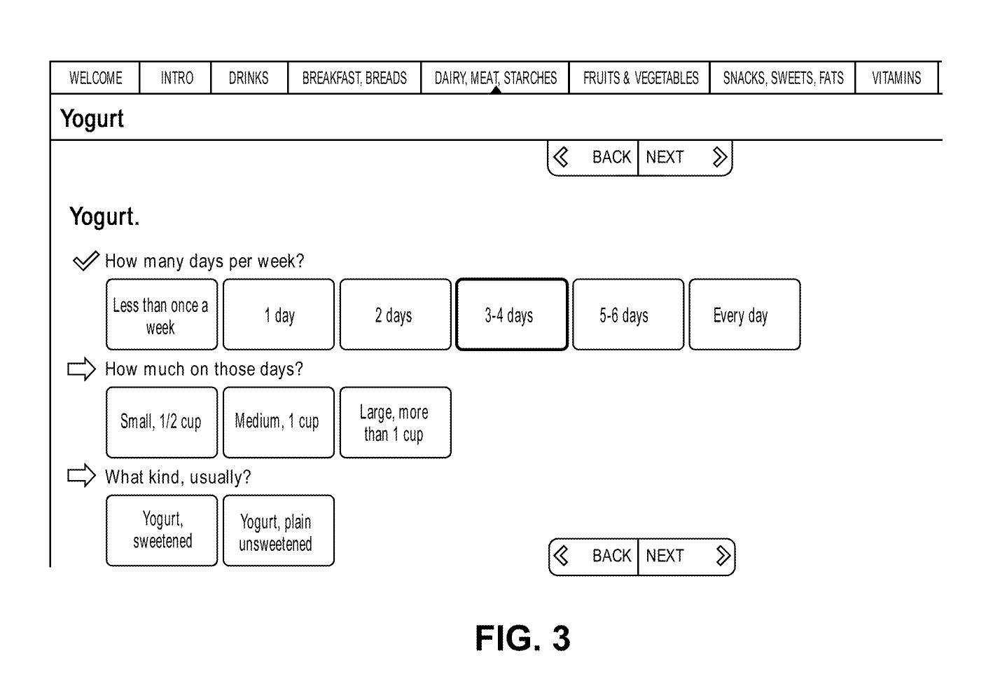

Yet another way in which the questionnaire is simplified is by presenting questions to the respondent only if they are required based on previous answers. For example, in the present illustration, if the food is eaten one day a week or more, the program displays the supplementary questions (see FIG. 3, which depicts an example embodiment of Questionnaire Simplification Tool). The Next button 150 is not live, and the program points to the further required answers. Upon receiving the required answers, the Question Specification document can determine what the next question should say, and the Next button 150 comes live. This way, the answer system presents additional questions to the respondent only if they are relevant based on the previous answer.

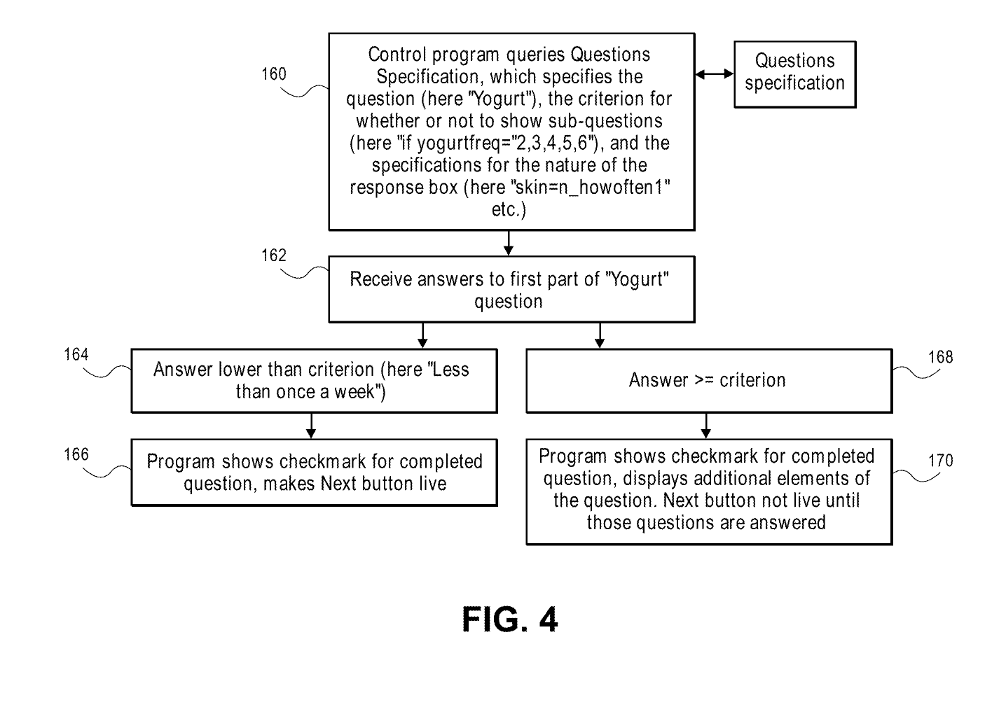

FIG. 4 presents a flow chart depicting one example embodiment of the Questionnaire Simplification Tool. When a respondent begins a questionnaire, the program queries the Questions Specification (160), determines the criteria for presenting further elements of the question, and presents the question, as in FIG. 2A. Answer is received (162). If respondent's answer is less than the criterion in the Questions Specification document (for example, if frequency is less than once a week) (164), that question is complete and the program makes the Next button 150 live, as shown in FIG. 2B (166). If the respondent's answer is greater than or equal to the criterion in the specification for that question (168), the program presents the subsidiary elements of that question, as in FIG. 3 (170).

### The Sidebar Running Total Tool

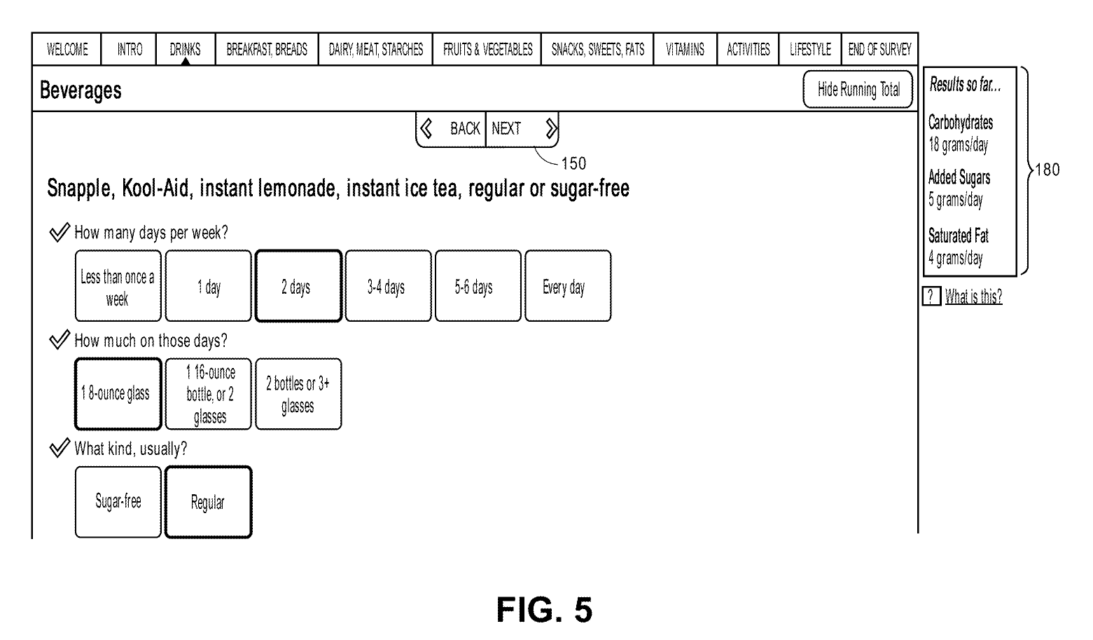

The Sidebar Running Total tool presents calculations to the respondent in real time, after receiving each response by the respondent. FIG. 5 depicts one embodiment of the Sidebar Running Total tool 180 pertaining to one type of food. In the particular screen that is depicted, first, second, and third questions are presented pertaining to the type of food. As the respondent adds information about his consumption of a food, the sidebar 180 updates the cumulative estimate of the total amount of the specified nutrient consumed by the respondent, immediately after the respondent adds the information.

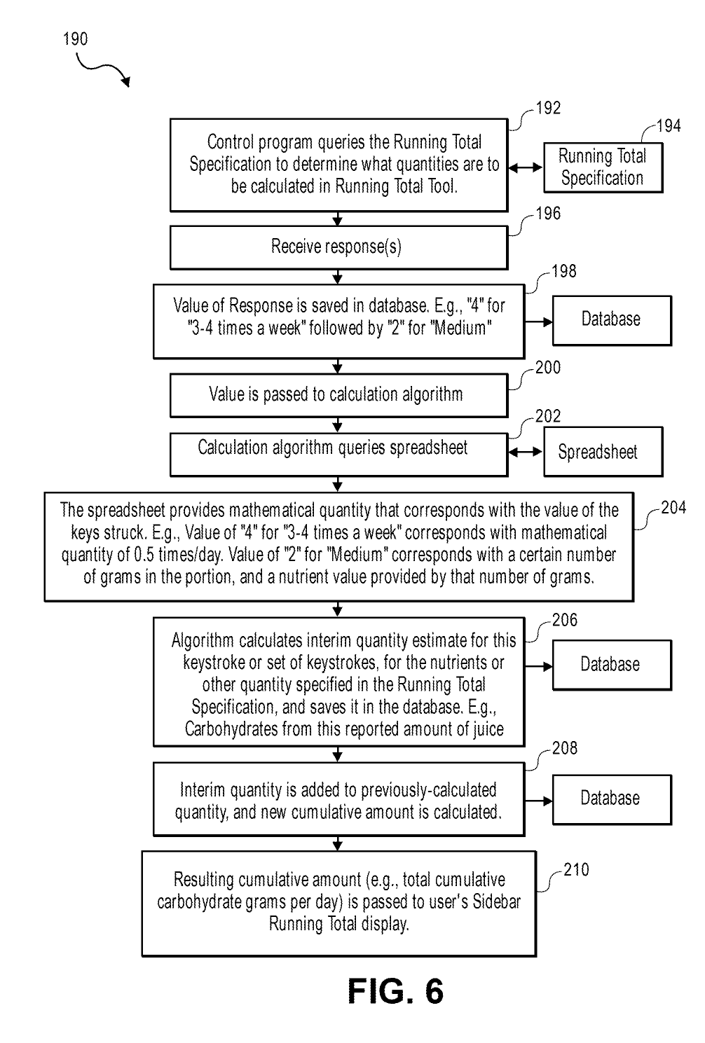

FIG. 6 is a flowchart depicting one example embodiment of the Sidebar Running Total calculation process 190. The system involves interactions among the control program, algorithms within the control program, a user end user interface program, a database or device's local storage to store results, a spreadsheet like document containing information about nutrient, portion size, food group content, and a Running Total Specification (shown below), among others. The Running Total Specification specifies which calculations shall be displayed in the Sidebar Running Total display 180. That specification is configurable such that multiple calculations can be shown simultaneously (e.g., estimates of calories, protein and minutes of daily activity).

When a user begins an electronic questionnaire, the control program queries the Sidebar Running Total Specification to determine which calculations are to be shown (192). The Sidebar Running Total Specification (194) is a document in which the questionnaire developer can specify what elements to display to the respondent in the Sidebar. More than one type of information can be displayed. In the context of a diet questionnaire, the running total of several different nutrients (e.g., carbohydrates and sugars) may be specified.

When an answer is entered by the user (e.g., in the form of a keystroke) (196), a program in the background accepts each answer completed by the respondent. The program saves in a database and/or a device storage a record of those answers/keystrokes for that question (198), so that the associated response values (answers) may be presented later to the respondent during the review in the Review Button Tool. The program passes the answer value to calculation algorithm (200) queries the spreadsheet-type document to determine the mathematical equivalent to be used for each keystroke (202, 204). The spreadsheet provides information that the control program can use to transform the simple key values into mathematical quantities (206). For example, for frequency of consumption, “2 days per week” translates to 2/7 or 0.286 per day. For portion, “one 8-ounce glass” may translate to 240 grams of the food. The type of food determines the nutrient amount. For example, regular Snapple provides 8.2 grams of added sugar for each 100 grams of the food. Using this information from the spreadsheet, the program performs the mathematical calculation to determine the nutrients represented by the respondent's answers about the food being examined (e.g., Snapple). For example, the calculation involves multiplication of the frequency per week of Snapple consumption times the amount consumed per day, and further adjusts that calculation based on further answers/keystrokes representing other aspects of the question (e.g., type of Snapple, regular or sugar-free). In this example, the calculation would be 0.286 (frequency) times 240 (amount) times 8.2 (nutrient density in the chosen type of food), all divided by 100. This interim nutrient amount provided by that food is added to the previous cumulative amount for that nutrient and saved to the database and/or device local storage (208).

The Sidebar Running Total is displayed to the questionnaire user (210), as shown in FIG. 5. It displays to the user the running total of accumulated calculations (e.g., carbohydrates, sugars) over all answers thus far. This display changes as each response/keystroke affects the specified calculations. The Sidebar Running Total may also display calculations relating to physical activities (e.g., calories burned, distance traveled), or a combination of nutrients and physical activities.

Some parts of the Sidebar Running Total Specification may be as follows:

```
<div class=”sidebarFeedback”>
        <div class=”sidebarFeedbackHeader”>
                Results so far ...
        </div>
        <div class=”sidebarFeedbackRow”>
                <b>Carbohydrates</b>
                <br/>
                ${=round($DT_CARB, 0)} ,nobr>grams/day</nobr>
        </div>
        <div class=”sidebarFeedbackRow”>
                <b>Added Sugars</b>
                <br/>
                ${=round($DT_FREESUGAR, 0)} <nobr>grams/
                day</nobr
        </div>
        <div class=”sidebarFeedbackRow”>
                <nobr><b>Saturated Fat</b></nobr>
                <br/>
                ${=round($DT_SATFAT, 0)} <nobr>grams/day</nobr>
        </div>
</div>
```

### The Interstitial Summaries Tool

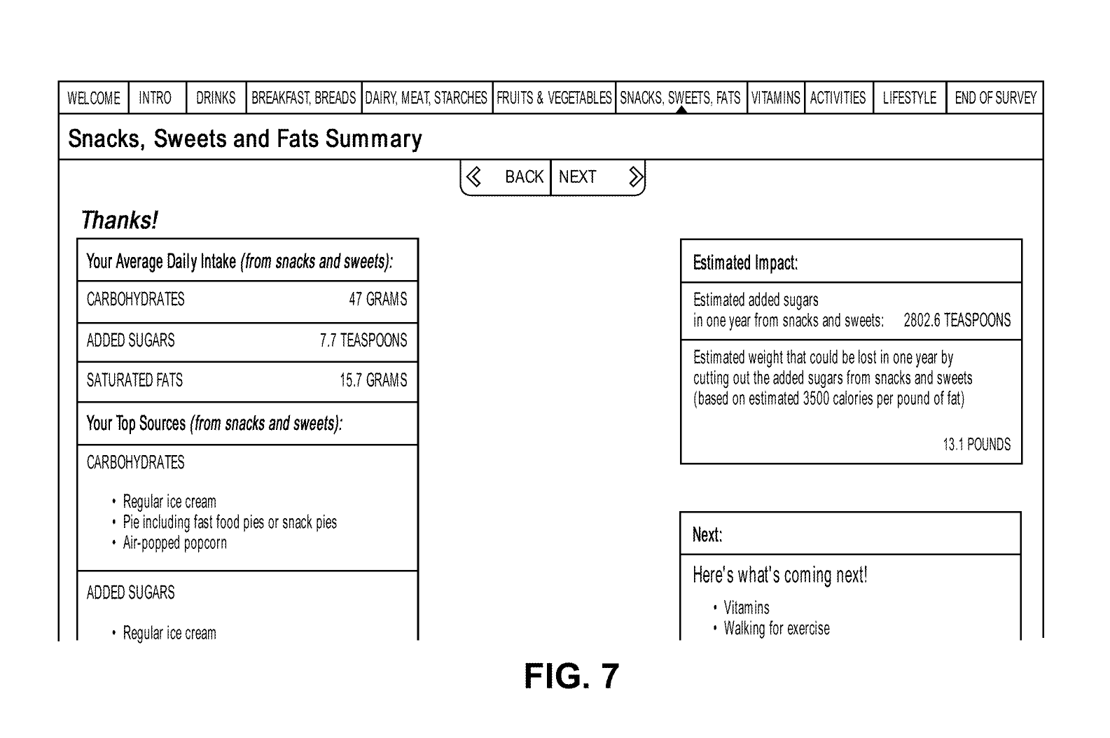

The Interstitial Summaries Tool presents interim calculations and other information to the questionnaire user, at time points before the full questionnaire is completed. This can serve to provide education about a group of questions (e.g., sugar in beverages the respondent drinks), can provide related data (e.g., how many pounds could be lost in a year if that sugar were removed), can alert the respondent about what is to come, and can provide a break from the monotony of a long list of questions. FIG. 7 depicts a screenshot of one embodiment of the Interstitial Summaries Tool. After the user has responded about his consumption of several foods in a category of foods (such as sweets and snacks), the program can provide a set of interim calculations of nutrients and other information relevant just to that subset of foods.

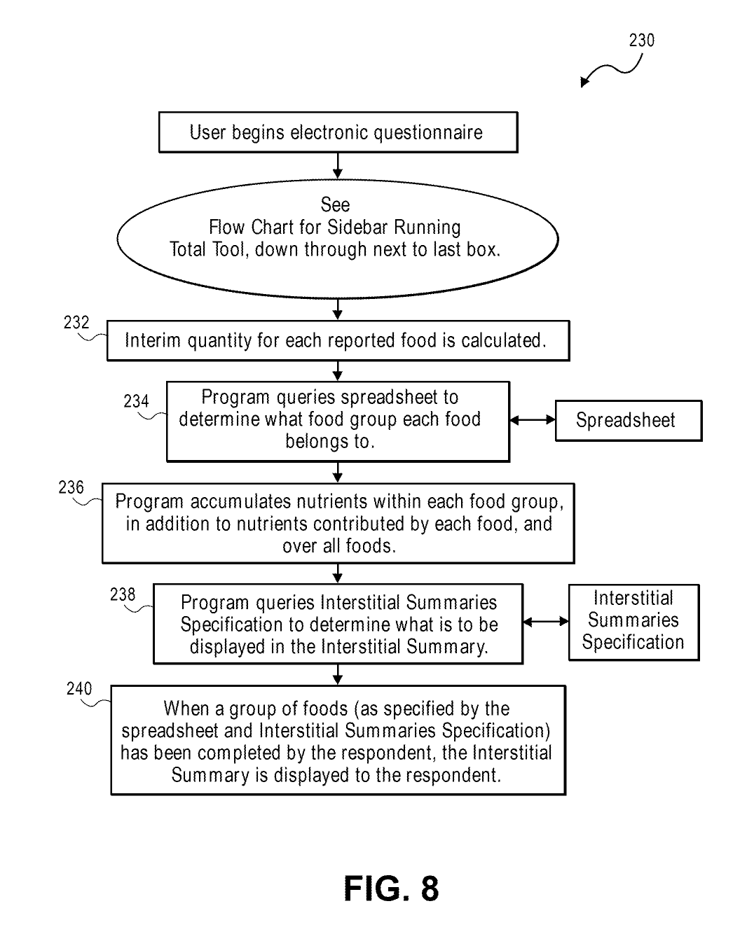

FIG. 8 depicts a flow chart of the Interstitial Summaries generation process 230 in accordance with an embodiment of the inventive concept. As in the Sidebar Running process 190, the computer program in the background is accumulating specified types of responses (here, nutrients). The quantity contributed by each food is calculated and saved by the program (232). The program accesses a document such as a spreadsheet to determine which food group a particular food belongs to (234). In this embodiment, the calculations carried out are like those described above under Sidebar Running Total Process. With each response about a food, the program accumulates the nutrient contributed not just by the food but by all foods in that food group (236). The Interstitial Summaries Specification is then accessed (238) to determine what information should be included in the Interstitial Summary report. When all the answers are received for a category of foods, the Interstitial Summary report is displayed (240).

The content of the Interstitial Summary to be displayed to the questionnaire user is specified by the Interstitial Summaries Specification, an example of which is shown below. The Interstitial Summaries Specification is a computer software program document in which the questionnaire developer can specify what elements to display to the respondent in the one or more Interstitial Summaries. This document specifies the words and layout to be displayed, and the resulting estimates. In this example, it specifies that the Interstitial Summary for the “Fats, Sweets and Snacks” food category should display grams of carbohydrates, teaspoons of added sugar and grams of saturated fat contributed by the “Fats, Sweets and Snacks” food category reported by the respondent; the foods contributing the most nutrient in this food category (“Top Sources”) in the respondent's diet; the total teaspoons of added sugar from beverages that this would add up to in a year in the respondent's diet; the “estimated impact,” in this case the total pounds that could be lost if the added sugars were cut out or reduced from the participant's usual diet in this food group; and the foods that will be shown next, as shown in FIG. 7.

An example section of the Interstitial Summary Specification may be as follows:

```
<div class=“questionnaireFeedback”>
  <div class=“questionnaireFeedbackOrangeHeader”>
  Thanks!
  </div>
  <div class=“questionnaireFeedbackTableLeftColumn”>
  <div class=“questionnaireFeedbackTableHeader”>
    Your Average Daily Intake <em>(from snacks and sweets):</em>
  </div>
  <div class=“questionnaireFeedbackTableRow”>
    <div class=“questionnaireFeedbackTableRowLabel”>
    CARBOHYDRATES
    </div>
    <div class=“questionnaireFeedbackTableRowValue”>
<?php
  * The following is an example of a PHP expression.
  * It starts with dollar sign, open brace, and equal sign,
  * contains a valid PHP expression, and ends with a close brace.
  * Note that the PHP expression MUST use dollar signs before
  * the variable names (a common mistake is to leave them out).
  * The round function takes a floating point number and the
  * number of decimal places to round it to.
  //
  3.Note: I am writing comments inside this php section so
  4.that they are ignored and not inserted into the final
  5.document. If I used <!-- html comments -->, they would
  6.end up in the final document, which we don't want.
?>
    ${=round($GROUP_SNAK_SWT_FAT_DIET_TOTAL_DT_CARB, 1)} GRAMS
    </div>
    <div class=“clear”/>
  </div>
  <div class=“questionnaireFeedbackTableRow”>
    <div class=“questionnaireFeedbackTableRowLabel”>
    ADDED SUGARS
    </div>
    <div class=“questionnaireFeedbackTableRowValue”>
    $
{=round($GROUP_SNAKSWT_FAT_DIET_TOTAL_DT_FREESUGAR_TEASPOONS, 1)}
TEASPOONS
    </div>
    <div class=“clear”/>
  </div>
  <div class=“questionnaireFeedbackTableRow”>
    <div class=“questionnaireFeedbackTableRowLabel”>
    SATURATED FATS
    </div>
    <div class=“questionnaireFeedbackTableRowValue”>
    ${=round($GROUP_SNAK_SWT_FAT_DIET_TOTAL_DT_SATFAT, 1)} GRAMS
    </div>
    <div class=“clear”/>
  </div>
  <div class=“questionnaireFeedbackTableHeader noTopBorder”>
    Your Top Sources <em>(from snacks and sweets):</em>
  </div>
  <div class=“questionnaireFeedbackTableRow”>
    <div class=“questionnaireFeedbackTableRowTopLabel”>
    CARBOHYDRATES
    </div>
    <ul>
<?php
  * The following is an example of a PHP conditional around some
  * text that also includes a simple variable substitution.
  * The if statement begins in the first php section, the
  * “if true” part goes to the next php section (for no top
  * drinks), the else statement is in that php section, the
  * “if false” part goes to the next php section after that,
  * the end of the if statement is in that section, and then
  * another if statement also begins in that section.
?>
<?php
  if (!$GROUP_SNAK_SWT_FAT_TOP_DT_CARB_1)
{ ?>
<?php
  * Inside the “if true” section of the if statement is a
  * simpe variable substitution, that begins with a dollar
  * sign, an open brace, followed by the name of a variable
  * WITHOUT A DOLLAR SIGN, then a closing brace. These simple
  * variable substitutions do not use dollar signs, and do
  * not support arbitrary php expressions. So numbers will
  * be printed with as many decimal places as they have.
  * And strings will not be escaped, so any html markup
  * in the strings will be formatted by the browser.
  //
  2.Note: Never insert variables that are values provided
  3.by the user, such as their first name, with this simple
  4.form of variable substitution, because that will enable
  5.them to inject dangerous html and JavaScript into the
  6.browser. which opens up a security hole. Instead, use
  7.a PHP expression with an equal sign, and call the
  8.PHP htmlspecialchars function on the string to safely
  9.escape it.
?>
    <li>(none)</li>
<?php } else {
?>
    <li>${GROUP_SNAK_SWT_FAT_TOP_DT_CARB_1}</li>
<?php
  }
  if ($GROUP_SNAK_SWT_FAT_TOP_DT_CARB_2) { ?>
    <li>${GROUP_SNAK_SWT_FAT_TOP_DT_CARB_2}</li>
<?php
  }
  if ($GROUP_SNAK_SWT_FAT_TOP_DT_CARB_3) { ?>
    <li>${GROUP_SNAK_SWT_FAT_TOP_DT_CARB_3}</li>
<?php
  }
?>
    </ul>
    <div class=“clear”/> </div>
  <div class=“questionnaireFeedbackTableRow”>
    <div class=“questionnaireFeedbackTableRowTopLabel”> ADDED SUGARS
    </div>
    <ul>
<?php
  if (!$GROUP_SNAK_SWT_FAT_TOP_DT_FREESUGAR_1) { ?>
      <li>(none)</li>
<?php } else {
?>
      <li>${GROUP_SNAK_SWT_FAT_TOP_DT_FREESUGAR_1}</li>
<?php
  }
  If ($GROUP_SNAK_SWT_FAT_TOP_DT_FREESUGAR_2) { ?>
      <li>${GROUP_SNAK_SWT_FAT_TOP_DT_FREESUGAR_2}</li>
<?php
  }
  if ($GROUP_SNAK_SWT_FAT_TOP_DT_FREESUGAR_3) { ?>
      <li>${GROUP_SNAK_SWT_FAT_TOP_DT_FREESUGAR_3}</li>
<?php
  }
?>
    </ul>
    <div class=“clear”/></div>
  <div class=“questionnaireFeedbackTableRow”>
    <div class=“questionnaireFeedbackTableRowTopLabel”> SATURATED FATS
    </div>
    <ul>
<?php
  if (!$GROUP_SNAK_SWT_FAT_TOP_DT_SATFAT_1) { ?>
    <li>(none)</li>
<?php } else {
?>
    <li>${GROUP_SNAK_SWT_FAT_TOP_DT_SATFAT_1}</li>
<?php
  }
  if ($GROUP_SNAK_SWT_FAT_TOP_DT_SATFAT_2) { ?>
    <li>${GROUP_SNAK_SWT_FAT_TOP_DT_SATFAT_2}</li>
<?php
  }
  if ($GROUP_SNAK_SWT_FAT_TOP_DT_SATFAT_3) { ?>
    <li>${GROUP_SNAK_SWT_FAT_TOP_DT_SATFAT_3}</li>
<?php
  }
?>
    </ul>
    <div
  class=“clear”/>
  </div>
  </div>
  <div class=“questionnaireFeedbackTableRightColumn”>
  <div class=“questionnaireFeedbackTableHeader”>
    Estimated Impact:
  </div>
  <div class=“questionnaireFeedbackTableRow”>
    <div class=“questionnaireFeedbackTableRowLabel”>
    Estimated added sugars<br/>
    <em>in one year</em>from snacks and
    sweets:<br/> </div>
    <div class=“questionnaireFeedbackTableRowValue”>
    <br/>
    $
{=round($GROUP_SNAK_SWT_FAT_DIET_TOTAL_DT_FREESUGAR_TEASPOONS_{—PER}_YEAR, 1)} TEASPOONS
    </div>
    <div
  class=“clear”/>
  </div>
  <div class=“questionnaireFeedbackTableRow”>
    <div class=“questionnaireFeedbackTableRowLabel”>
    Estimated weight that could be lost in one year
    by cutting out the added sugars from snacks and sweets
    (based on estimated 3500 calories per pound of fat)
    </div>
    <div class=“questionnaireFeedbackTableRowValue”>
    <br/>
    <br/>
    $
{=round($GROUP_SNAK_SWT_FAT_DIET_TOTAL_DT_FREESUGAR_POUNDSGAINED_PER_YEAR, 1)} POUNDS
    </div>
    <div
  class=“clear”/>
  </div>
  <br/>
  <br/>
  <div class=“questionnaireFeedbackTableHeader”> Next:
  </div>
  <div class=“questionnaireFeedbackTableRow”>
    <div class=“questionnaireFeedbackTableRowComingNext”> Here's
    what's coming next!
    </div>
    <ul>
    <li>Vitamins</li> <li>Walking for
    exercise</li> <li>Hiking</li>
    <li>Running</li> <li>Biking</li>
    <li>Swimming</li> <li>Cardio
    machines</li> <li>Exercise
    video</li> <li>Exercise class</li>
    <li>Dance class</li> <li>Dancing
    for fun</li> <li>Other aerobic</li>
    <li>Strength training</li>
    <li>Pilates, core strengthening</li>
    <li>Yoga, Tai chi</li>
    <li>Work outdoors</li>
    <li>TV</li> <li>Online</li>
    </ul>
    <br/>
    <img src=“/static/images/user/ActivitySection.png” width=“188” height=“100”
style=“margin-left: 40px;”/>
    <br/>
  </div>
  </div>
  <div class=“clear”/>
</div>
```

### The Review Button Tool

The Review Button Tool permits the questionnaire respondent to go back and reconsider his answers, with the aim of improving the accuracy of response. As a participant goes through a questionnaire, the respondent is typically not comparing his answers to those he has given already, and can't compare them to questions that have not yet been asked. As a result, responses may fall into a pattern, which could be corrected if the respondent were to review the answers after all were completed.

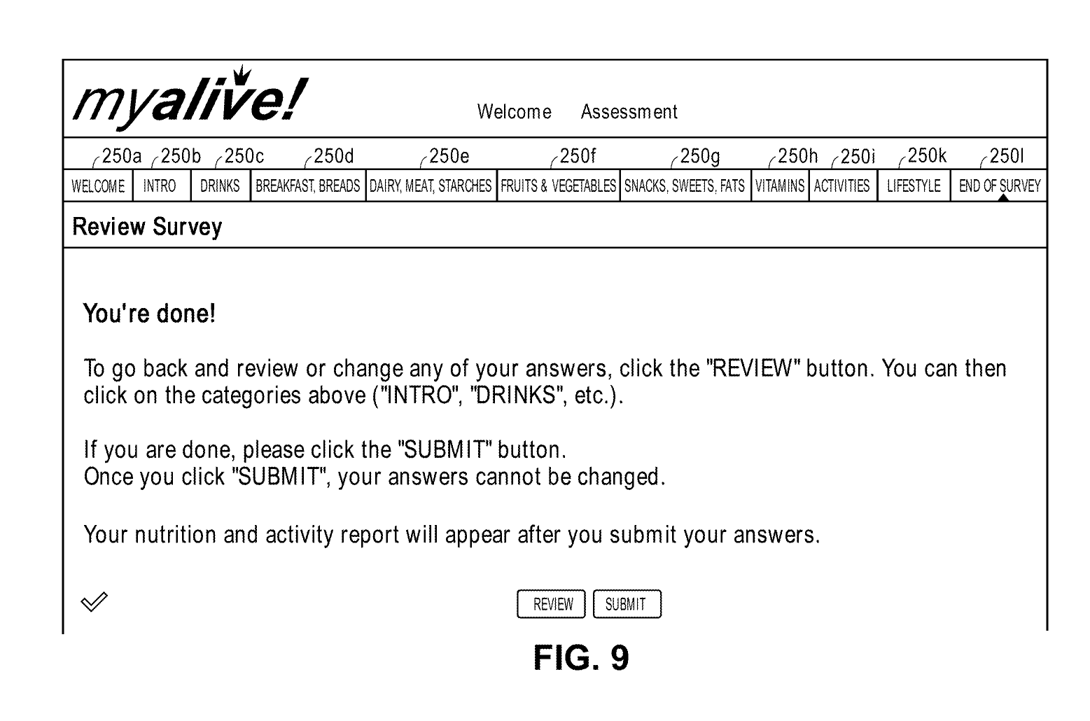

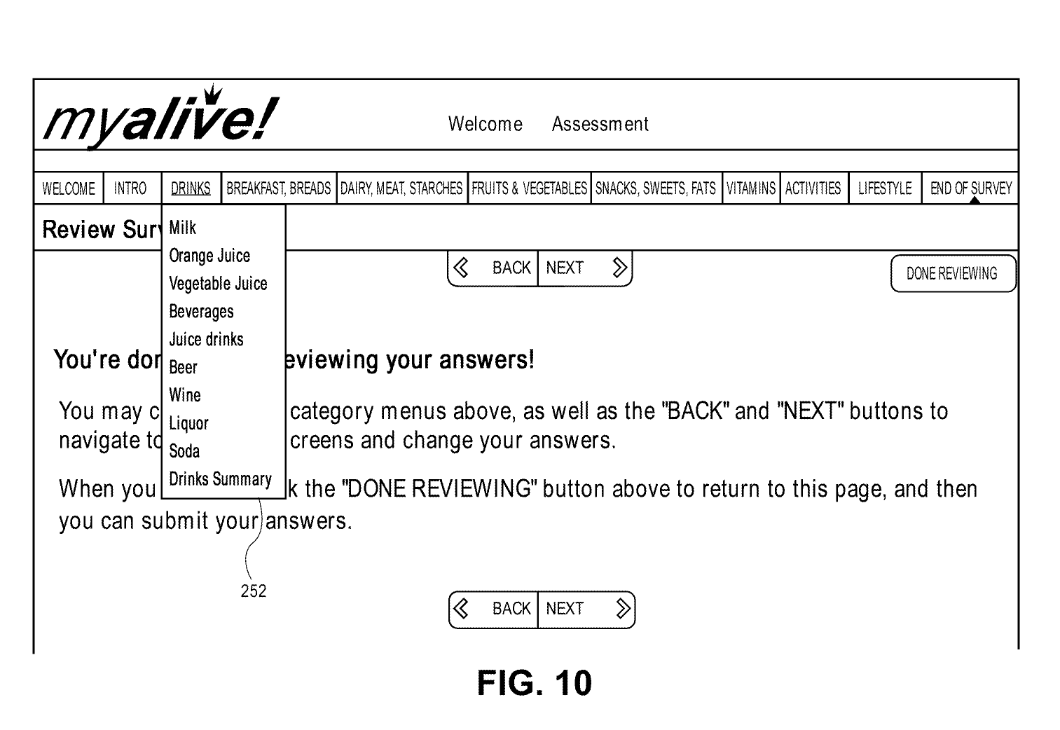

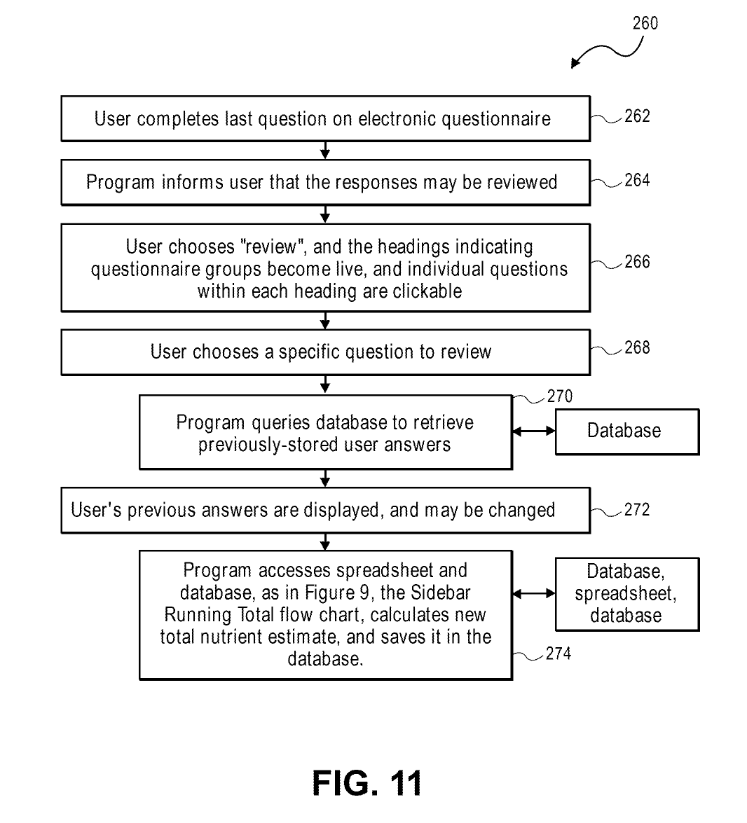

FIG. 9 and FIG. 10 are screenshots of one embodiment of the Review Button Tool, and FIG. 11 depicts a flowchart of an example embodiment of the Review Button process. FIG. 9 presents the initial view in one embodiment. In FIG. 10, the user has chosen to begin the review; the background of that screen is grayed out, the user has chosen to review answers in the Drinks tab, and individual items in that section are now clickable. After the respondent completes all the questions, the program offers him the opportunity to review his answers and optionally change them. At the top of the screen are tabs 250a-1 (collectively referred to as tabs 250) that the respondent may activate to jump to a desired food category. These tabs 250 represent sections of the questionnaire, or groups of answers. During the Review process, the tabs 250 become “live.” FIG. 10 illustrates an embodiment that has a drop-down menu 252 showing sub-categories within a food tab. The program explains that the respondent may review the answers, and that the tabs will become live and they may jump to a section and to a specific question (e.g., a specific food) in that section.

When the user chooses a question to modify, the program accesses the database (or a device's local storage), retrieves the previous answers, and displays them to the user. The respondent may change those answers. The program accesses the database and spreadsheet (or alternative database), and recalculates the nutrients resulting from that food after the changed responses. In this embodiment, the calculations carried out may be similar to what is described above under “Sidebar Running Total Tool.” Those replace the previous calculations for that food, and the final estimate (e.g., total Calories from all foods) is instantly recalculated.

FIG. 11 depicts the Review process 260 in accordance with one embodiment. After receiving a response to the last question, a notice is presented offering the respondent option to review his answers (264). If the respondent chooses to review his answers, the tabs 250 become live (266), each tab representing a food category. Upon receiving a user selection (e.g., click of a tab and selection of a sub-category if there is one) (268), previously-received answers are retrieved from database (270) and displayed for the user (272). The user may or may not change his answer. New total nutrient estimate is calculated and saved if the answer is changed (274).

### Review-by-Sorting Tool

The Review-by-Sorting tool allows the respondent to review multiple responses to a multi-item questionnaire by comparing them, and to modify individual responses by rearranging (dragging) the sequence of items in a sorted list. For example, by seeing his previously-estimated frequency of consuming potatoes and black beans adjacent to one another, he may realize that he has over-estimated the frequency of black beans. The Review-by-Sorting tool allows a participant to fine-tune his responses.

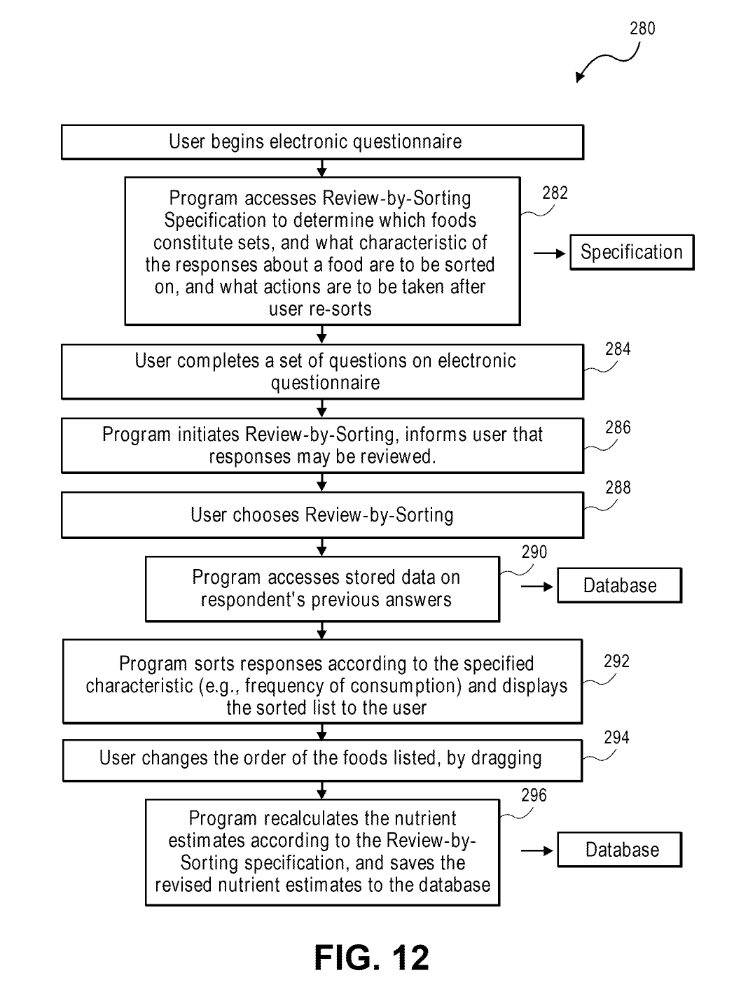

FIG. 12 depicts a flow chart of one embodiment of the Review-by-Sorting process 280. Generally, the Review-by-sorting process 280, which entails sorting foods according to answers associated with them, may be triggered either when all foods are completed, or after completion of a set of foods. To begin, the program accesses the Review-by-Sorting Specifications to determine what questions (in this case, foods) constitute a set (282). After answers are received for all the questions in a set (284), the program may offer the user the opportunity to review that set of foods, or the review may be offered without asking (286), depending on the specifications. If the user chooses to activate the Review-by-Sorting process (288), the program will access the stored answers to that set of questions (290), and will sort all responses in the set by the answer unit (e.g., frequency of consumption) (292), and then present the respondent with the sorted list.

Responses of the same answer unit will be grouped together, to form “answer unit categories.” For example, all foods in the set that were reported as being consumed 5-6 times/week will be grouped together, etc. The respondent can then drag the items on-screen, rearranging their order, moving the item within the item's original answer unit category, or into a new answer-unit category (294). For example, although both potatoes and beans may have been reported in the 3-4 times/week category, the user may eat potatoes more often than beans within that category, and may drag potatoes to be above beans. Or, the user may realize that in fact he does not eat beans even as often as 3 times/week, and may drag them to a different answer-unit category.

Once the user has completed moving the items, the analysis program will impute new responses to items that were moved. For items that change order but remain in the same answer unit category, the program will impute the new response to be the midpoint between the original answer unit category and the answer unit category that is nearest and in the direction the item was moved. For items that change order and move to a new answer unit category, the program will impute the new response to be the answer unit category into which the item was moved. After recalculation, the revised nutrient estimates are saved to the database (296).

### the Most Frequently Used Item Selector Tool

Food frequency questionnaires often ask more than a single food within a question. For example, a question might be “How often do you eat oranges or tangerines?” The nutrient content is similar but not identical, and the two items differ in portion size. The calculation algorithm may apply an internal weighting system when calculating nutrient and/or portion size of the question as a whole that could reflect, for example, population-wide data on frequency of oranges vs. tangerines. The Most-Frequently-Used item selector permits the respondent to identify one item in a list of similarly grouped items that the respondent himself most frequently uses, by clicking the name of the item. The selected item will then be used in the analysis algorithm, to modify the weighting applied to the different items in the group and thus more accurately reflect the respondent's behavior.

Although described in terms of a nutrient questionnaire, the tool is applicable in other domains. For example, a questionnaire might ask “How often do you participate in team sports like basketball or baseball?” Again, though similar, the two activities have different energy expenditure characteristics that might be refined by the Most-Frequently-Used Item Selector process.

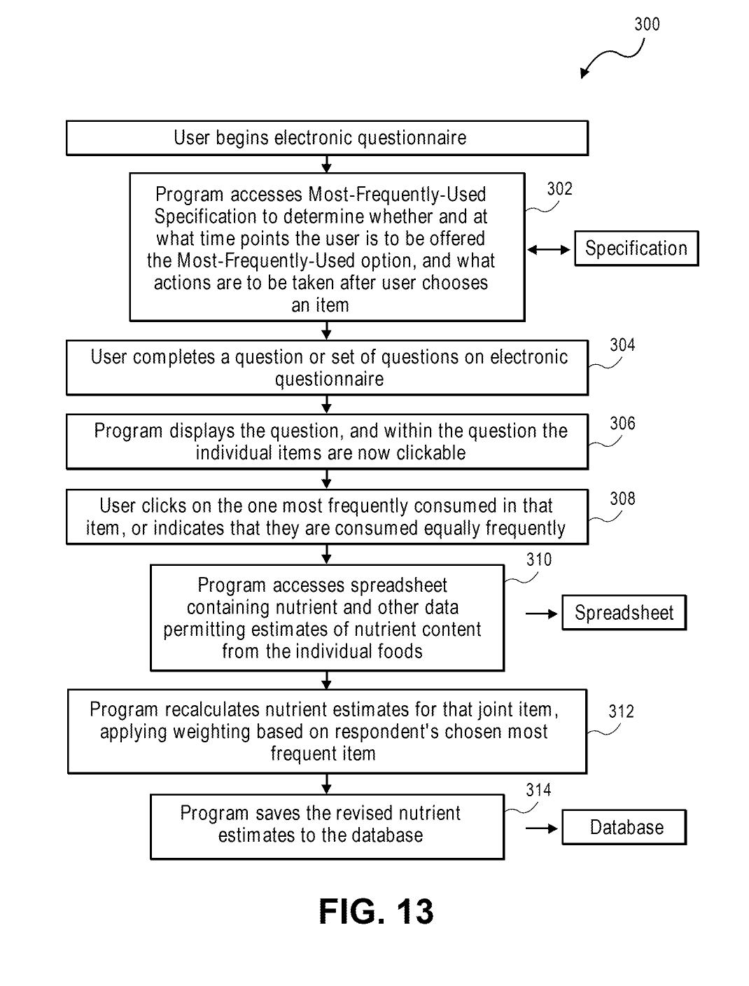

FIG. 13 depicts a flow chart of one embodiment of the Most Frequently Used item Selector process 300. The program accesses the specification for the Most Frequently Used Item selector process 300 that indicates whether and when questions may be offered for review, which questions, and which sub-parts of the question may be selectable (302). The program displays the combined question (e.g., oranges and tangerines), with each of the items separately selectable (306), and receives answers (304). The user may either indicate that both are eaten equally frequently, or may click on/select one as the most frequently eaten (308). The program accesses a spreadsheet containing nutrient information on the specific sub-items in that question (310), and recalculates the nutrient estimates with a different weighting among the two or more items. For example, if the respondent indicates that tangerines are the most frequently used item, the program may give a higher weighting to the nutrient content of tangerines than to oranges, instead of a simple average of the two items (312). The resulting nutrient estimates are stored in the database (314).

### Activity Plan Tool

Behavior change programs, in general, aim to help participants improve their behaviors in a wide array of behavior types, from alcohol and smoking to depressive ideation. The Activity Plan tool, which may be part of the method and system of this disclosure, will be described in relation to a program to improve physical activity. Scheduling systems have been developed previously, including scheduling of physical activity. The system described here, however, is distinguishable in that the participant can specify and adjust the long-term behavioral target (e.g., 150 minutes per week of aerobic activity), and can easily adjust all components of a schedule (e.g., days per week, minutes per day, number of weeks to reach the target, activity type) on a single screen, and the program recalculates instantly in real time with each user input, without requiring a call to a remote application server.

The Activity Plan Tool may be implemented as a computer software application. This disclosure consists of algorithms and interfaces to determine baseline level of activity, to calculate and display a default plan, to generate new plans in response to user activity or inactivity, and to permit a participant to review and change the various components of the plan, with instant behind-the-scenes recalculation by the algorithm.

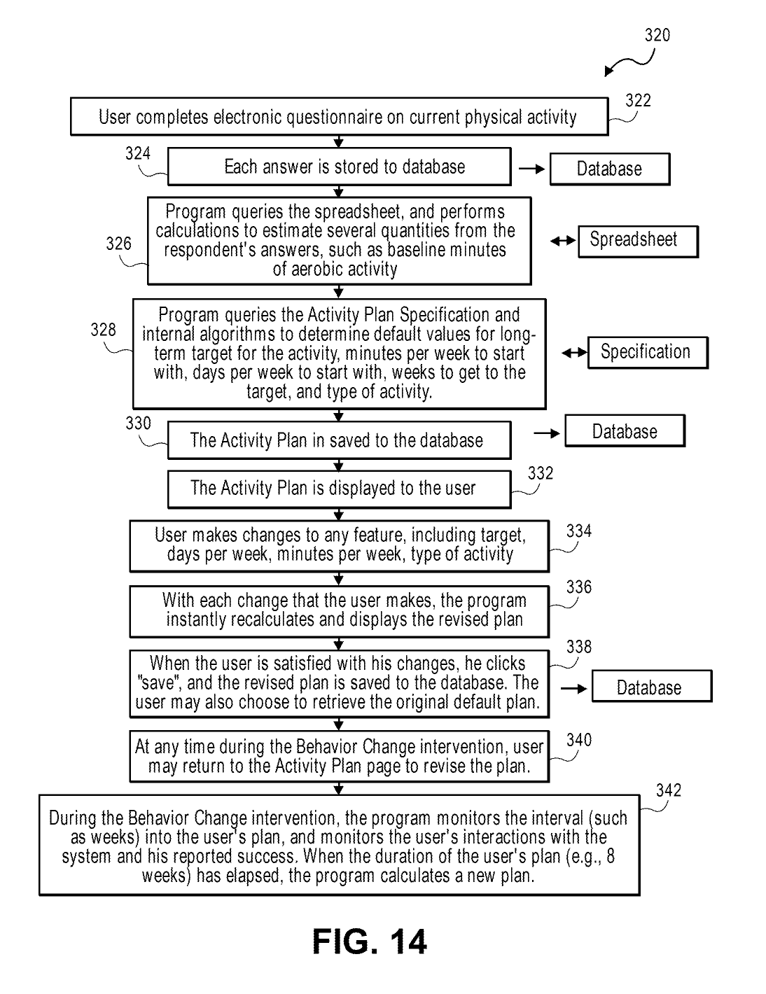

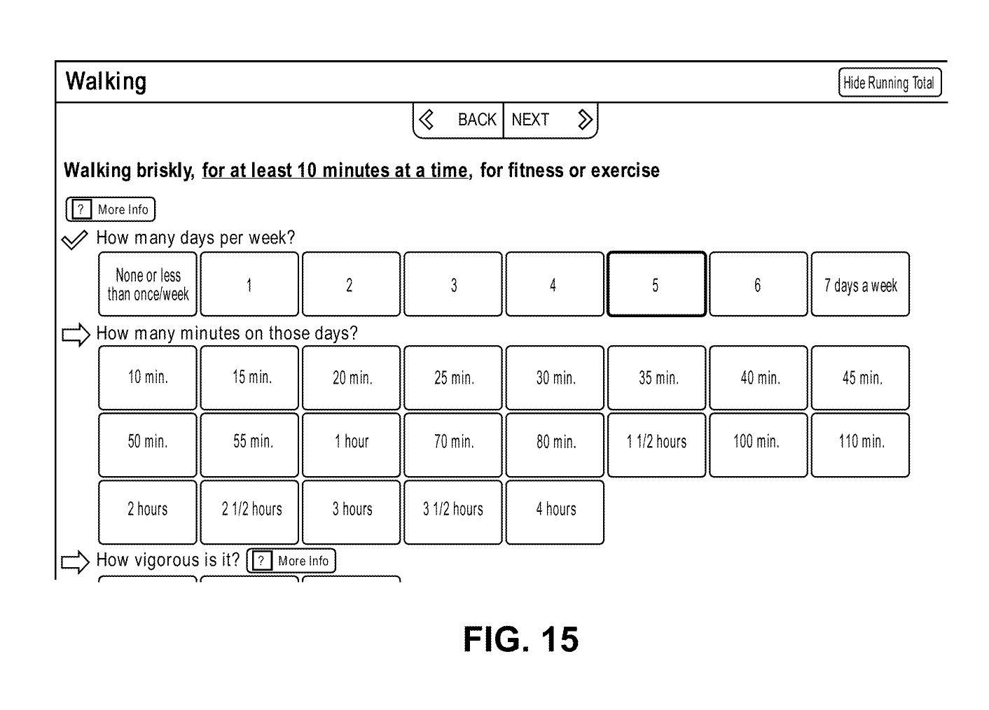

FIG. 14 depicts a flowchart of an embodiment of the Activity Plan process 320. As a first step in developing an activity plan for the user, an assessment of baseline level of the behavior is administered through an electronic questionnaire (322). The answers are stored in the database (324). Based on questions or calculations, the computer program determines key factors relevant to the development of the activity plan, such as age, body mass index, baseline days that the participant performs the activity of interest (in this example, aerobic activity) (326). After the respondent answers a series of questions like those in FIG. 15 below, the computer program accesses a spreadsheet or internal algorithm, and calculates a baseline level of one or more attributes, such as minutes of aerobic activity, minutes of moderate activity, energy expended, and others (328). FIG. 15 depicts an example embodiment of one question in a questionnaire about baseline activity level.

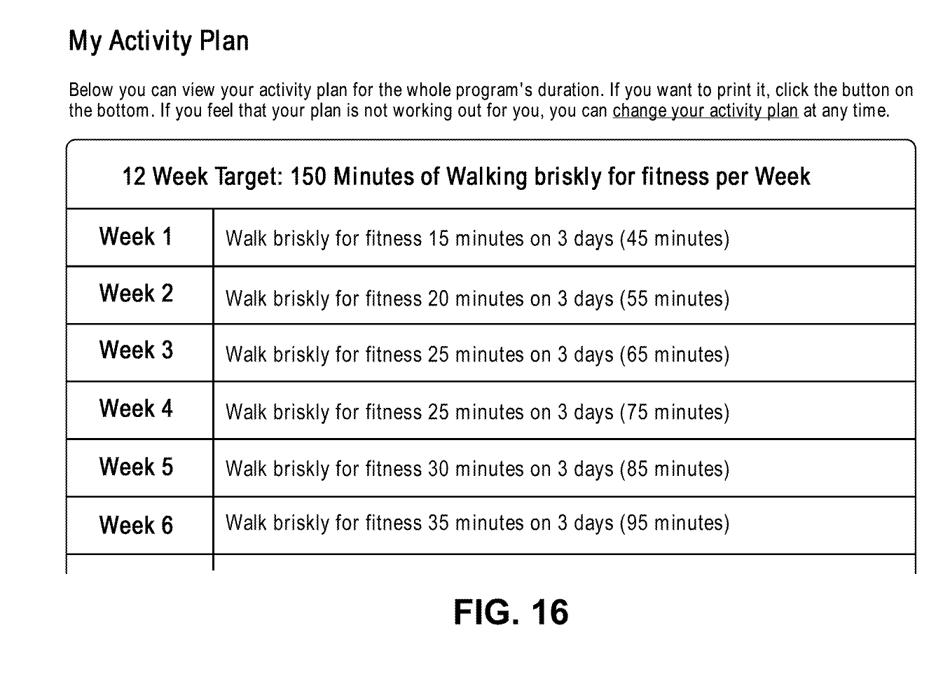

Based on the Activity Plan Specification, a default activity plan is calculated, saved (330), and displayed instantly (e.g., within less than a few seconds of the user's entering the last response about his activities) (332). FIG. 16 depicts an example of what may be presented to the user. The computer algorithm creates default values depending on characteristics of the participant, which may include the following:
1) Reported baseline days per week of the target behavior. As a default, the weekly plan begins with the same number of days per week as currently reported by the participant. If no days of aerobic activity have been reported, the default is 3 days.
2) Reported current total minutes per week of aerobic activity. As a default, the activity plan begins with a first week that is 10 minutes per week more than the reported baseline amount. If no current aerobic activity is reported, the default plan begins with a preset duration, e.g. 45 minutes per week.
3) As a default for type of activity, the plan uses the reported current most frequently performed type of activity. If no current aerobic activity is reported, the default is brisk walking
4) Long-term target for total minutes per week of aerobic activity. If the current reported minutes per week is less than 150, the default is 150 (about 30 minutes on five days). If the reported baseline is more than 150, targets are set to the next interval, 225, 300, or 450 minutes per week.
5) Age and body mass index (BMI). These determine how rapidly the minutes per week will increment week to week. Older and heavier persons will progress more slowly, take more weeks to get to the long-term target.
6) Weeks to target. The default is determined by the above-mentioned factors.

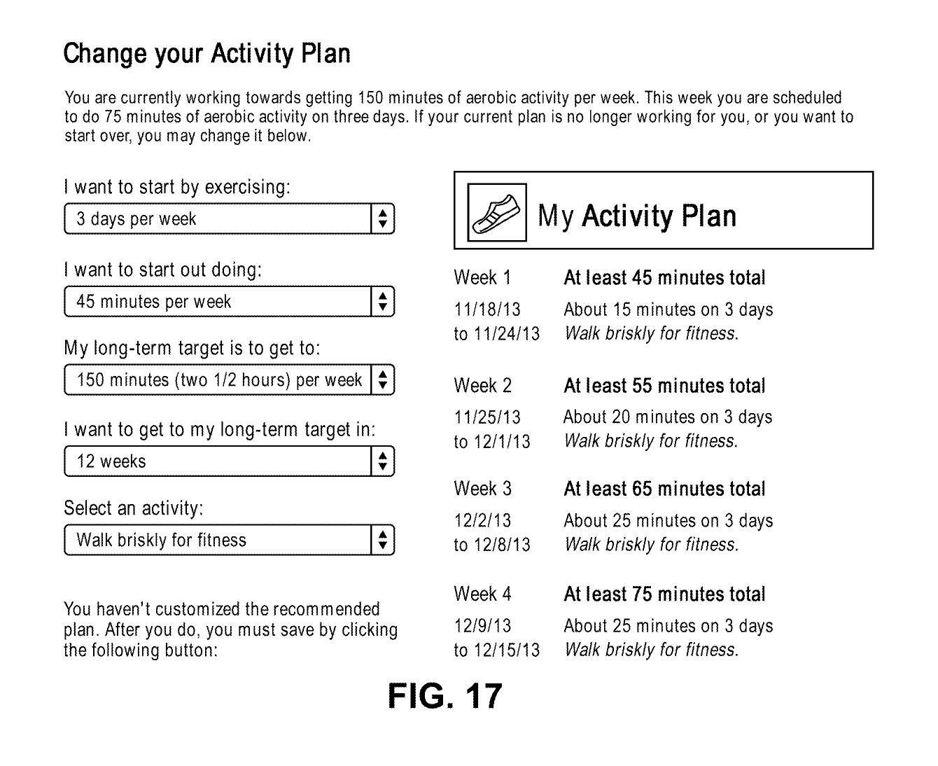

When the default activity plan is displayed, the participant may be presented with the option to modify the plan. These modifications may be done either immediately, or at any time during the course of the behavior-change intervention (334). FIG. 17 depicts an example of the format by which all aspects of the activity plan can be changed by the participant, including target minutes, days per week, weeks to target, etc. The activity plan displayed to the participant changes as each answer/keystroke affects the specified calculations (336). After changes are saved by the participant, they are saved to the database (338). However, the original default plan has also been saved, and the user may retrieve it if he decides it is preferable to the changed plan. The user may return to the Activity Plan page and modify the plan at any time during the Behavior Change Intervention (340). Resulting changes are saved to the database.

The Activity Plan covers the number of weeks specified either by default or as modified by the user; for example, for 6, 8, or 12 weeks. When the allotted duration has expired, the Activity Plan Tool automatically generates a new plan. The Activity Plan tool can generate a new plan that takes account of the user's interaction with the Behavior Change Intervention, and of the user's reported success with the plan. For example, if the planned duration is complete and the user has reported success with the behavior specified in the plan, the new plan may suggest moving to a new higher target. If the user has not interacted at all with the plan, the new plan may start over with the original plan (342).

An example embodiment of Specification for the Activity Plan tool may be as follows:

### INITIAL CREATION OF ACTION PLAN

To permit users to create their action plan, we will show them information about where they are now, and show them dropdowns with suggested values, which they can modify:
their current level: actionPlan_minutesThisWeek_initial
long-term Target: actionPlan_Target
weeks to get to their Target: actionPlan_weeksToTarget
days per week they want to do it: actionPlan_daysPerWeek
   FIRST, create defaults for these dropdowns:
   Set current level variable from FFQ analysis:
   actionPlan_minutesThisWeek_initial=GROUP_AEROBIC_ACTIVITY_MINS

### Defaults for Target and Weeks, Based on Age and BMI

These are used in calculations of initial default actionPlan_Target and initial default actionPlan_weeksToTarget, for dropdowns:

| | | Default_weeksTo | Default_minutesTo |
|---|---|---|---|
| Age | BMI | Target | Increment |
| 18-39 | <35 | 6 | 20 |
| 18-39 | >=35 | 10 | 10 |
| 40-54 | <30 | 6 | 20 |
| 40-54 | 30-34 | 8 | 15 |
| 40-54 | >=35 | 12 | 10 |
| 55-99 | <30 | 8 | 15 |
| 55-99 | >=30 | 12 | 10 |

Calculate initial long-term target to suggest in dropdown. Default is 150 minutes per week. But if they're already close to or over 150, start them out with a higher target. So if they would get to 150 by week 4, start them out with a higher target:
If (GROUP_AEROBIC_ACTIVITY_MINS+10)+(3*default_minutesToIncrement)<150, then make actionPlan_target=150
If (GROUP_AEROBIC_ACTIVITY_MINS+10)+(3*default_minutesToIncrement)>=150, then make actionPlan_target=225
If (GROUP_AEROBIC_ACTIVITY_MINS+10)+(3*default_minutesToIncrement)>=225, then make actionPlan_target=300
If (GROUP_AEROBIC_ACTIVITY_MINS+10)+(3*default_minutesToIncrement)>=300, then make actionPlan_target=450
If (GROUP_AEROBIC_ACTIVITY_MINS+10)+(3*default_minutesToIncrement)>=450, then make actionPlan_target=600
Calculate initial weeks to Target to suggest in dropdown.
Old and/or fat go slower.

### If GROUP_AEROBIC_ACTIVITY_MINS<=45,

actionPlan_weeksToTarget=default_weeksToTarget

### If GROUP_AEROBIC_ACTIVITY_MINS>45,

actionPlan_weeksToTarget=round((actionPlan_target−GROUP_AEROBIC_ACTIVITY_MINS)/default_minutesToIncrement)
Calculate initial days per week to suggest in dropdown.
if daysAerobic_rand<=3 OR GROUP_AEROBIC_ACTIVITY_MINS<=45, actionPlan_daysPerWeek=3

### ELSE

actionPlan_daysPerWeek=daysAerobic_rand
Initialize a variable that will indicate whether user wishes to progressively increase minutes per week, or wishes to hold at a certain number of minutes per week. This is used in the “Change mode. It's included here in order to keep the formulas identical. actionPlan_proceed is set to zero when they tell us they want to stick at the current minutes/day & not continue to progress.
actionPlan_proceed=1
NOW CALCULATE to draw their step-by-step Action Plan:
Calculate the following in order. These use variables calculated initially OR as changed by the user in the dropdown boxes above.
1. First, calculate minutes for first step:
actionPlan_minutesThisWeek_base=greater of (45)
(actionPlan_minutesThisWeek_initial+10)
[start at 45, or add 10 min to their current level]
2. Next, calculate how many total minutes we need to add after their first step in order to get to their target.
actionPlan_totalMinutesToAdd=(actionPlan_target−actionPlan_minutesThisWeek_base)*actionPlan_proceed
7. Next, calculate number of minutes to add each step after the first. actionPlan_minutesToIncrement=actionPlan_totalMinutesToAdd/(actionPlan_weeksToTarget−1)
8. For steps after step 1, iterate over n steps in the action plan, to show user the complete multiple-week plan to get to his Target. n=actionPlan_weeksToTarget (as possibly modified by user):
actionPlan_minutesThisWeek_TEMP=actionPlan_minutesThisWeek_base+(actionPlan_minutesToIncrement*(step−1))
[Note: In the beginning, ‘step’ here represents PrediabetesMainBranchStep. When they are initially creating their action plan, step will be null. So probably need a substitute variable to represent step, just during the creation of the action plan to display to user.]
5. For each week, calculate minutes per day, for display on action plan: actionPlan_minutesPerDay_temp=actionPlan_minutesThisWeek_temp/actionPlan_DaysPerWeek
Round (up or down) actionPlan_minutesPerDay_temp to nearest multiple of
5. Then actionPlan_minutesThisWeek [not temp]=rounded actionPlan_minutesPerDay*actionPlan_DaysPerWeek
[This makes total minutes in that week equal to the product of days and minutes per day.]
6. For the LAST week in the plan, we want the actionPlan's minutes this week to always equal exactly the number of minutes they chose as their target (e.g., 150). So for the “x minutes on y days”, don't do this rounding. Just report the target as the total, and the “minutes per day” as the actual dividend. So for example, if their target were 90 minutes per week, and their number of days were 4, the last week of the action plan would say “90 minutes total” and “at least 22.5 minutes on 4 days”.

### DISPLAY MULTI-WEEK ACTION PLAN:

Week 1, dates a to b actionPlan_minutesThisWeek minutes total
actionPlan_minutesPerDay minutes on actionPlan_DaysPerWeek days first chosen activity

### Week 2, etc

only down through the week in which the Target minutes is reached
Exception to how to display multi-week action plan:
If their chosen number of days is <=2 days per week, then always include an example of 3 days in addition. So if chosen # days/week=2:
Week 1, dates a to b actionPlan_minutesThisWeek minutes total
actionPlan_minutesPerDay minutes on [one] days
   or
actionPlan_minutesPerDay minutes on [three] days first chosen activity

### DISPLAY TO USER

Create Your Action Plan

You are currently doing [actionPlan_minutesThisWeek_initial] minutes of moderate or vigorous aerobic activity per week. (This doesn't include any strengthening activities you may do.) [if target=150]: Health experts recommend doing a minimum of 150 minutes per week (about 30 minutes on about five days).

[if target>150]: You are close to or above the recommended minimum of 150 minutes per week. But that's just a minimum. Health experts recommend doing as much as 300 minutes per week (about an hour on five days),
We have created a plan that we think will work for you.
But everybody is different. Some people want to make big changes right away, while others prefer to make change slowly.
If the plan on the right works for you, click the “Next” button. If you want to change your plan, you may do so below. Our recommendations are in bold.
I want to start by exercising:
[Dropdown defaulted to actionPlan_daysPerWeek, but changeable in units from 1 to 7] days per week
My long-term target is to do:
[Dropdown defaulted to actionPlan_target, but changeable in 15-minute increments starting at 30 and ending at 600.]

### [Text:

45 minutes/week. Example: 15 minutes on 3 days
60 minutes/week. Example: 20 minutes on 3 days
75 minutes/week.
90 minutes/week. Example: 18 minutes on 5 days
105 minutes/week.
120 minutes/week. Example: 30 minutes on 4 days
135 minutes/week.
150 minutes/week. Example: 30 minutes on 5 days
proceed in 15 minute increments, but giving examples only on major points: 225, 300, 375, 525, 600.
I'll get to my long-term target in:
[Dropdown defaulted to actionPlan_weeksToTarget, but changeable in units from 1 to 24] weeks
Select an activity:
[Dropdown defaulted to “Walk briskly for fitness”]
[Activities on the dropdowns:
Walk briskly for fitness

### Hike

### Jog, run

Bike outdoors

### Swim

Use cardio machines or exercise bike
Use an exercise video
Take an exercise class
Take a dance class

### Dance for fun

Do some other aerobic activity

### DISPLAY GOALS IN ACTIVITY PART OF GOALS EMAIL:

Note that we're NOT going to display in subsequent emails the number of days they've chosen previously, but rather we are going to display what their Action Plan calls for.
Display goal:
I will [dropdown-activities] for [dropdown: actionPlan_minutesPerDay] per day on each of [dropdown-action Plan_daysPerWeek] days
and (optional)
I will [dropdown-activities] for [dropdown-minutes] per day on [dropdown-days] days
[For second one, no defaults. Days 0 to 7, minutes 0 to 120 in 5-minute increments]
[Activities on the dropdowns:
Walk briskly for fitness

### Hike

### Jog, run

Bike outdoors

### Swim

Use cardio machines or exercise bike
Use an exercise video
Take an exercise
class Take a dance
class Dance for fun
Do some other aerobic activity
For second optional goal (no default. Maybe a ‘--’ shows in dropdown):
Strengthening: machines
Strengthening: yoga

### Strengthening: Pilates

Strengthening: Something else
Walk briskly

### Hike

### Jog, run

Bike outdoors

### Swim

Use cardio machines or exercise bike
Use an exercise video
Take an exercise
class Take a dance
class Dance for fun
Do some other aerobic activity

### Change Action Plan—Feb. 13, 2013

### TO PERMIT THE USER TO CHANGE HIS ACTION PLAN

This is intended to be structured very similarly to the Creation of Action Plan. We will show them the following:
their current long-term target and current minutes per week based on current step of Action Plan
opportunity to change their starting days per week
opportunity to change their starting minutes per week
opportunity to tell us they want to hold at that level, not progress
opportunity to change their target
opportunity to set the weeks to get to new target

When the user clicks on “Change Action Plan”, the current plan is displayed. That is, it shows the dates representing the weeks of the existing plan, with the planned number of minutes as before. This is the case regardless of whether the current date is within that range or much later than the end of that range.

Create defaults (items to be bolded) for the dropdowns to display to user:
current days/week
current minutes/week
current target
current weeks to target (even if it is past)
current activity

### DISPLAY TO USER

[On the right, display the table showing the current action plan]
Change your Action Plan
You are currently working towards getting actionPlan_target minutes of aerobic activity per week. This week you are scheduled to do actionPlan_minutesThisWeek minutes of aerobic activity. If your current plan is no longer working for you, or you want to start over, you may change it below.
[actionPlan_daysPerWeek]
I want to start by exercising:
[Dropdown defaulted to actionPlan_daysPerWeek, but changeable in units from 1 to 7] days per week

[actionPlan_minutesThisWeek]

I want to start out doing:
[Dropdown defaulted to current actionPlan_minutesThisWeek, but changeable in 10-minute units from 30 to 150, then in 15-minute increments to 225, then in 30-minute increments to 600.]
[150 and 300 should add hours. e.g.:
130 minutes per week
140 minutes per week
150 minutes (2½ hours) per week
. . .
300 minutes (5 hours) per week
600 minutes per week
   Below the dropdown box:
   “Tip: If you want to stay at this level for a while and not keep increasing, set your long-term target (below) to equal this number of minutes per week.”

[actionPlan_target]

My long-term target is to get to:
[Dropdown initially defaulted to current actionPlan_target, but changeable in 15-minute increments starting at 30 and ending at 600.]
[On the fly, this must always be >=actionPlan_minutesThisWeek chosen above] [If actionPlan_minutesThisWeek=actionPlan_target, set actionPlan_proceed=0]
Display only if actionPlan_proceed is 1 (continue to proceed):
[actionPlan_weeksToTarget
I want to get to my long-term target in:
[Dropdown defaulted to actionPlan_weeksToTarget, but changeable in units from 1 to 24] weeks]
Below the dropdown box:
“Tip: If your current action plan is progressing too fast, you can slow it down by choosing a longer time to get to your target. Or if it's moving too slowly, choose a shorter time to get there.”
Select an activity: [Activities
on the dropdowns: Walk
briskly for fitness

### Hike Jog,

run
Bike outdoors

### Swim

Use cardio machines or exercise bike
Use an exercise video
Take an exercise class
Take a dance class

### Dance for fun

Do some other aerobic activity
CALCULATE to draw their revised step-by-step action plan:
Calculate the following in order. These use variables calculated initially OR as changed by the user in the dropdown boxes above.
1. Minutes for first step of new plan:
Either their current actionPlan_minutesThisWeek or the actionPlan_minutesThisWeek which the user chose in the dropdown above.
10. How many total minutes we need to add after their first step in order to get to their target.
If user has chosen to hold at current level (actionPlan_proceed=0), this is zero If user has chosen to progress:
actionPlan_totalMinutesToAdd=(actionPlan_target−actionPlan_minutesThisWeek)*actionPlan_proceed
3. How many minutes to add each step after the first.
actionPlan_minutesToIncrement=actionPlan_totalMinutesToAdd/(actionPlan_weeksToTarget−1)
4. For subsequent steps, iterate over n steps in the action plan, to show user the complete multiple-week plan to get to his Target. n=actionPlan_weeksToTarget (as possibly modified by user):
actionPlan_minutesThisWeek_TEMP=actionPlan_minutesThisWeek+(actionPlanminutesToIncrement*(step−1))
[Note: ‘step’ here represents PrediabetesMainBranchStep. (??Or maybe the upcoming step?) At this point it's a real step]
5. For each week, calculate minutes per day, for display on action plan: actionPlan_minutesPerDay_temp=actionPlan_minutesThisWeek_temp/action Plan_DaysPerWeek
Round (up or down) actionPlan_minutesPerDay_temp to nearest multiple of 5.
Then actionPlan_minutesThisWeek [not temp]=rounded actionPlan_minutesPerDay*actionPlan_DaysPerWeek
[This makes total minutes in that week equal to the product of days and minutes per day.]
6. For the LAST week in the plan, we want the action Plan's minutes this week to always equal exactly the number of minutes they chose as their target (e.g., 150). So for the “x minutes on y days”, don't do this rounding. Just report the target as the total, and the “minutes per day” as the actual dividend. So for example, if their target were 90 minutes per week, and their number of days were 4, the last week of the action plan would say “90 minutes total” and “at least 22.5 minutes on 4 days”.
DISPLAY MULTI-WEEK ACTION PLAN—As before
But if user has chosen to ‘hold’ (actionPlan_proceed=0), all subsequent weeks through the end of the program will show the same total minutes, x minutes on y days, and activity.

### ActionPlan_WhenEndReached Feb. 13, 2013

When they reach the end of their Action Plan (that is, the last week of their Plan), we will generate a new Action Pan for them, using the following rules:
1) If they have reached the end and they NEVER reported accomplishing ANY activity weekly goal they were offered, generate a new Action Plan that is the same as their original action plan. I.e., as if they are just starting.
2) If they have reached the end and their last ACCOMPLISHED goal has minutes/week that is >=their previous target (which was shown on the last week of their expired action plan), then generate a new plan with a higher target:
if previous target was <150, new target=150
if previous target>=150 & <225, new target=225
if previous target>=225 & <300, new target=300
if previous target>=300 & <450, new target=450
if previous target>=450, new target=600
For the starting number of minutes per week of the new plan, use the calculated number of minutes per week (the product of x minutes on y days) from the last goal that they reported having accomplished.
For the starting number of days per week of the new plan, use the # days/week of their last SELECTED goal.
Use initial defaults for rate of progress
   3) If they are intermediate between those two: If they have reached the end and they have reported ACCOMPLISHING at least one activity weekly goal during their old plan (but not their final target goal), generate a new Action Plan as follows:
For their new target: Use their last accomplished number of minutes per week as if it were their GROUP_AEROBIC_ACTIVITY_MINS. Then use the rules on page 2 to calculate their new target.
For the starting number of minutes per week of the new plan, use the calculated number of minutes per week (the product of x minutes on y days) from the last goal that they reported having accomplished.
For the starting number of days per week of the new plan, use the # days/week of their last SELECTED goal.
Use initial defaults for rate of progress
   When we generate a new Action Plan for them:

1) Send an email which includes their new Action Plan

2) The text at the top of the email will be conditionalized as follows:
1) If they are in category 2 above, say something like “Great job! You successfully completed your Action Plan. We think you should keep moving forward, so we've created a new Action Plan for you below. If this plan is too fast or too slow for you, or you want to stick at this level for a while, you can change your plan by clicking this link.”
2) If they are in category 1 above, say something like “Do you want to start over? We have created a new Action Plan for you. See below.”
3) If they are in category 3 above, AND the number of minutes from their last accomplished goal is at least 50% of the target minutes from their previous Action Plan, say something like “Nice job! You are part way to your target. We think you should keep moving forward, so we've created a new Action Plan for you, below.”
4) If they are in category 3 above, and the number of minutes from their last accomplished goal is less than 50% of the target minutes from their previous Action Plan, say something like “You can do it! We have created a new Action Plan for you.”

### The Personal Support Team Tool

The Personal Support Team Tool promotes and facilitates social support to the participant from friends and family. Since social support is important for successful behavior change, it is common to simply suggest that a participant engage the support of family and friends. The process and system described here is unique in that it incorporates a module that prompts the participant to seek the support of friends and family, proactively sends an invitation to the friends/family indicated by the participant, actively reminds friends and family of the need to support the participant, and actively shares with the friends and family the activities or information being provided to the participant.

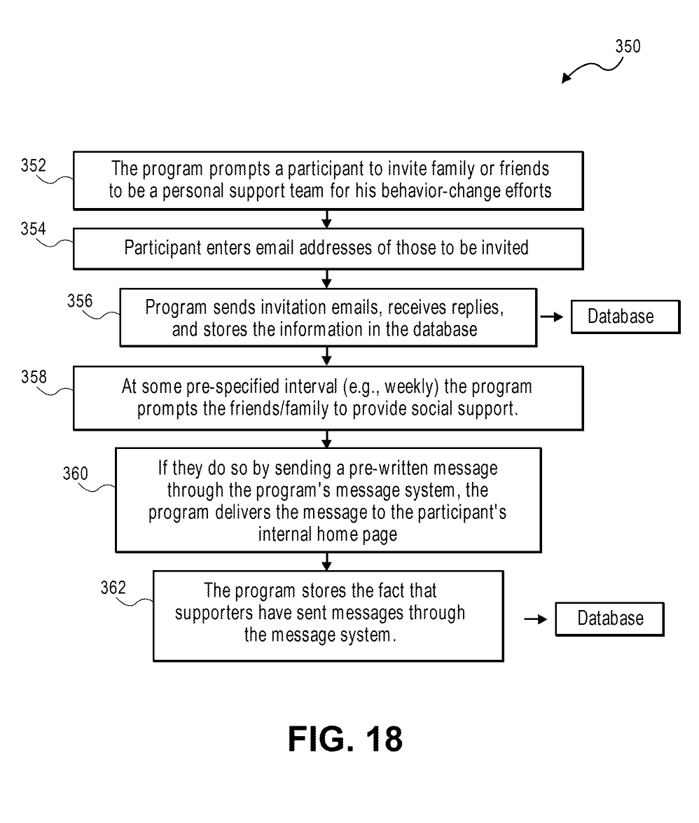

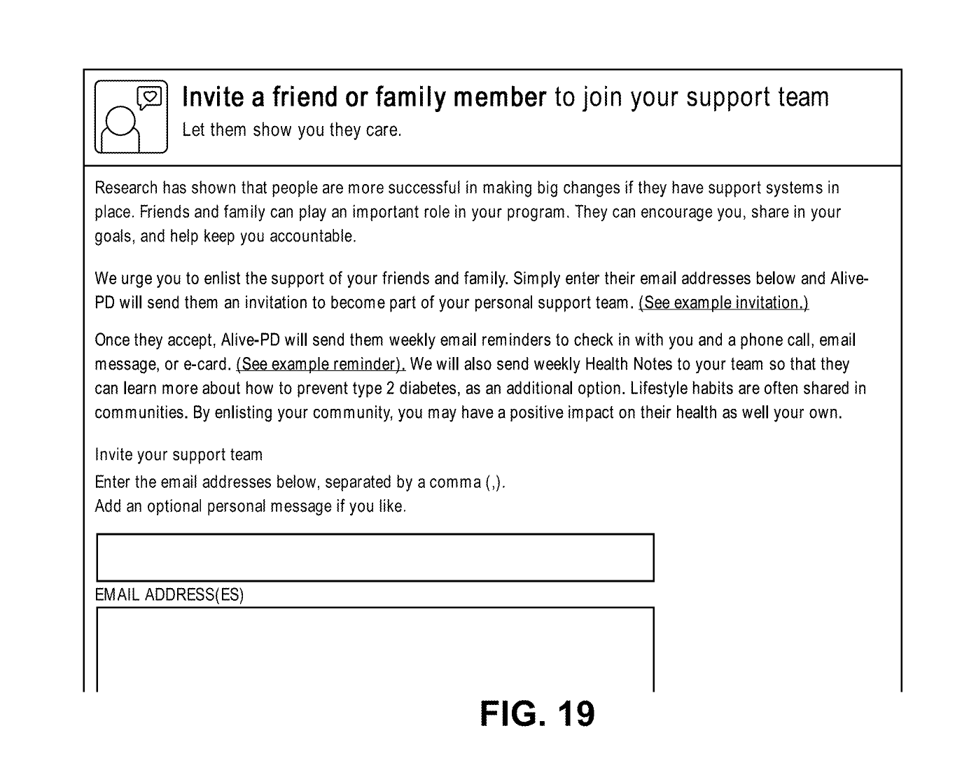

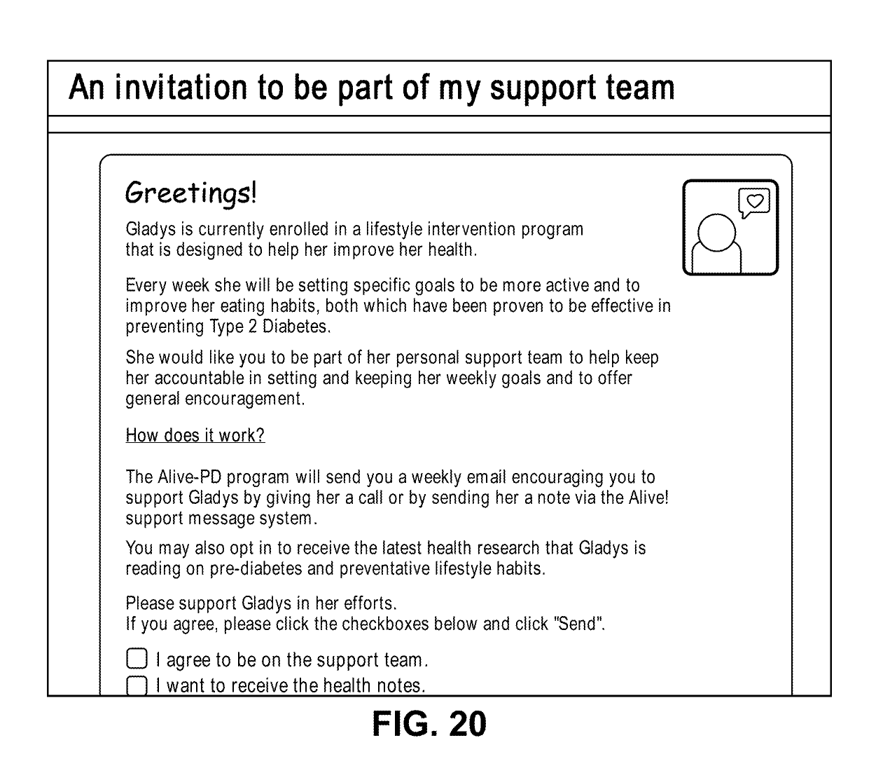

FIG. 18 depicts a flowchart of one embodiment of the Personal Support Team process 350. The program prompts the participant to seek encouragement and support from friends and family (352). The participant is encouraged to suggest the email addresses of friends/family as a support team, as seen in an example page shown in FIG. 19. In addition, the participant is shown what an invitation will look like (FIG. 20 shows an example embodiment of such invitation). If participant enters email addresses of those he wants to invite (354), the program sends invitation emails and collects any replies (356). These activities are stored in the database (356). The program includes automatic prompts to remind the invited friends and family to provide support to the participant (358). The prompts may be sent, for example, at a regular interval. Any message sent by the friend/family, for example by using a pre-written message in the system, will be delivered to participant's home page (360). The program records that messages were sent through the message system (362).

That invitation is then sent to suggested friends and family. The advantage of this component is that the friends/family will be automatically invited, rather than the participant having to remember to do so.

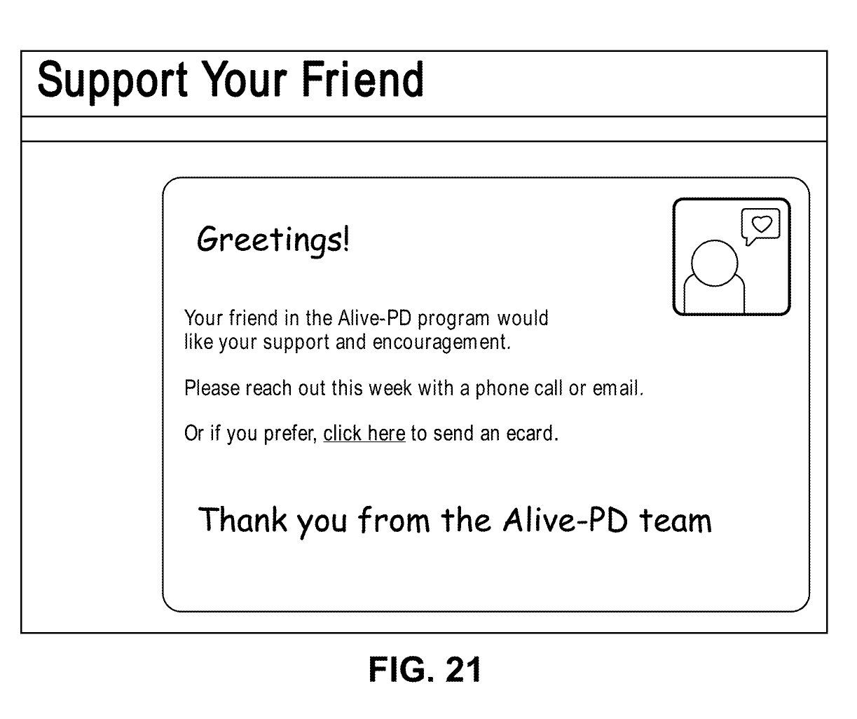

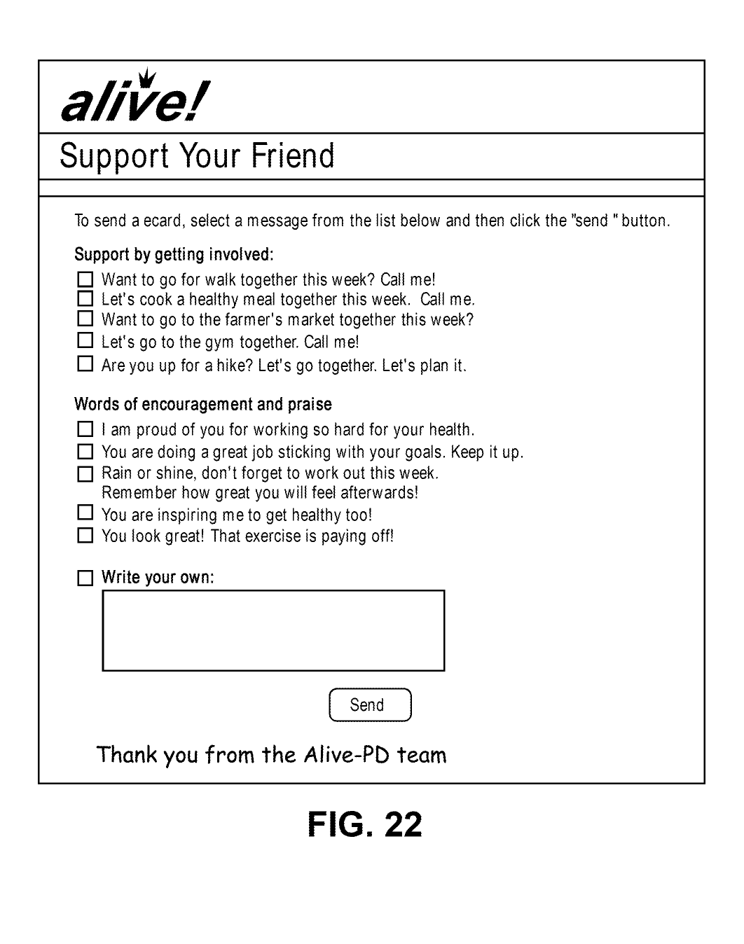

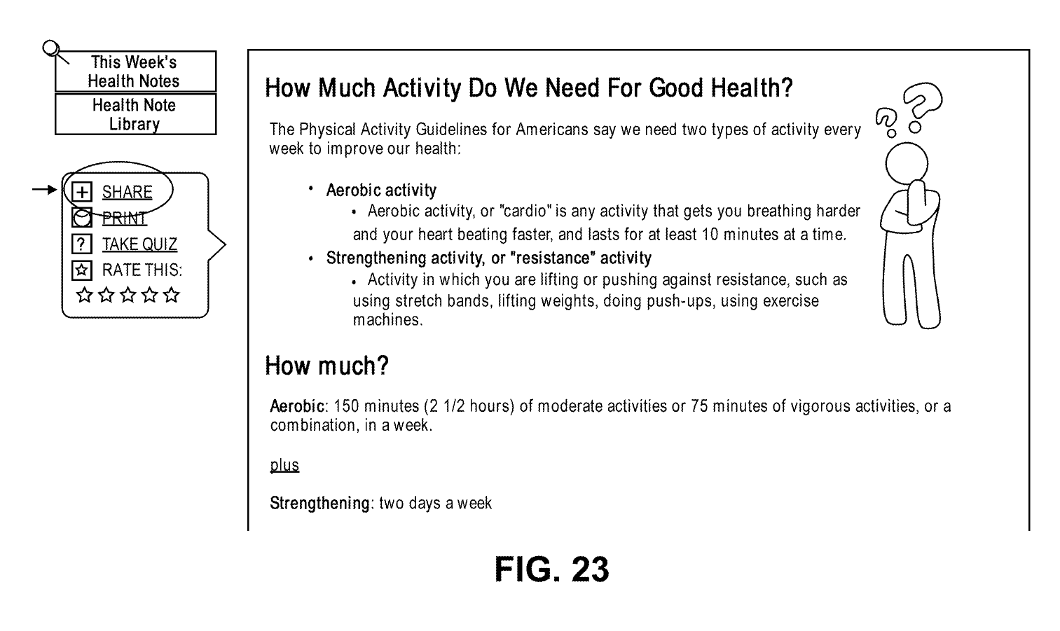

When friends or family agree to provide the requested social support, they are reminded to do so with weekly communications by email, smartphone, smartwatch, or other means (FIG. 21 depicts an example message that may be presented to the family/friends). The friends/family have the option of accessing an electronic interface (e.g., web, email, smartphone, smartwatch) and directing the system to send a free-form or pre-written message to the participant; a number of pre-written messages and categories are provided (FIG. 22 depicts an example of a user interface or page that may help the friend/family create their supportive message). In addition, they may receive the health information the participant is reading, if they have opted to do so. Finally, the participant may also share the health information from the Behavior Change Intervention with others (an example of which is shown in FIG. 23). This helps to build a community of persons around the participant who understand his goals and can support him.

### The Prevention Points Tool

It is well-established that people who participate more actively in behavior-change programs are more successful in actually changing their behavior. A key issue in web-based behavior-change programs is the need to maintain an adequate level of participation. The Prevention Points Tool is one component of that effort to maintain participation.

A set of types of interactions with the system is defined in a specification, including how many points earned for each. In one embodiment, the behaviors and accompanying points could be as follows: choose a goal=20 points; report on a goal=10 points; answer a quiz=10 points; log weight=10 points; send a support message=20 points; complete a questionnaire=100 points. Points are equivalent to pennies, and accumulate over the course of the duration of the weeks or months of the intervention.

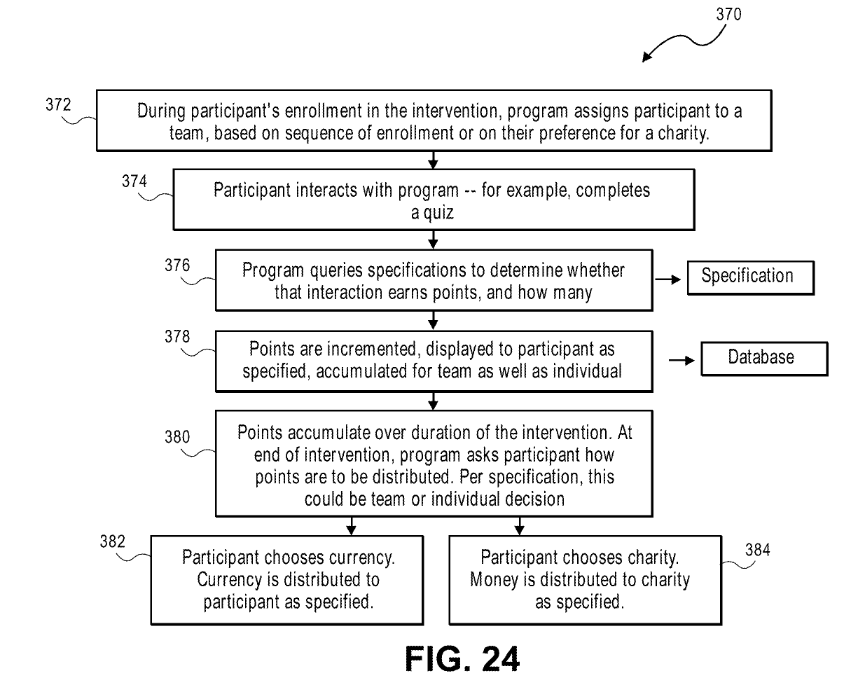

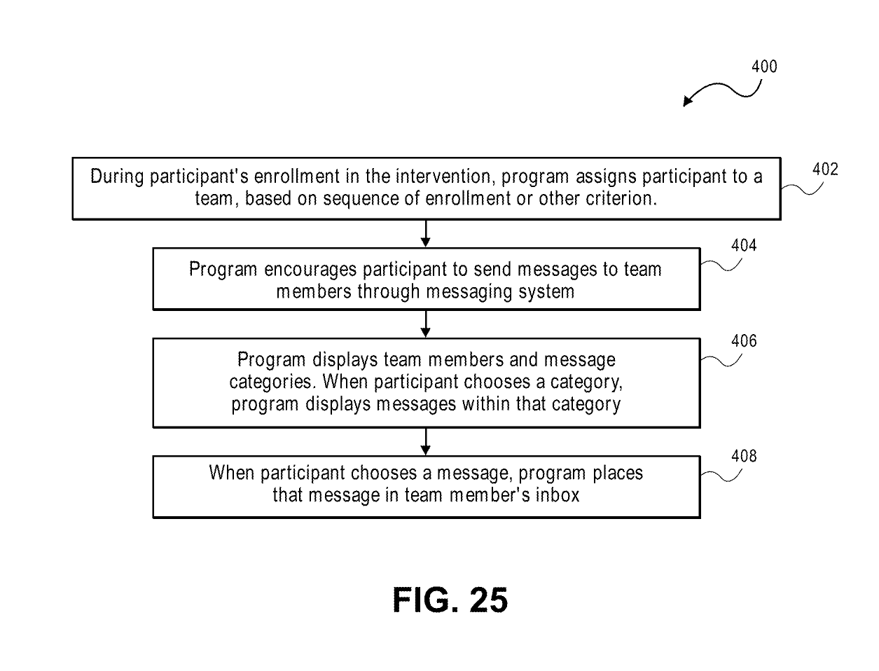

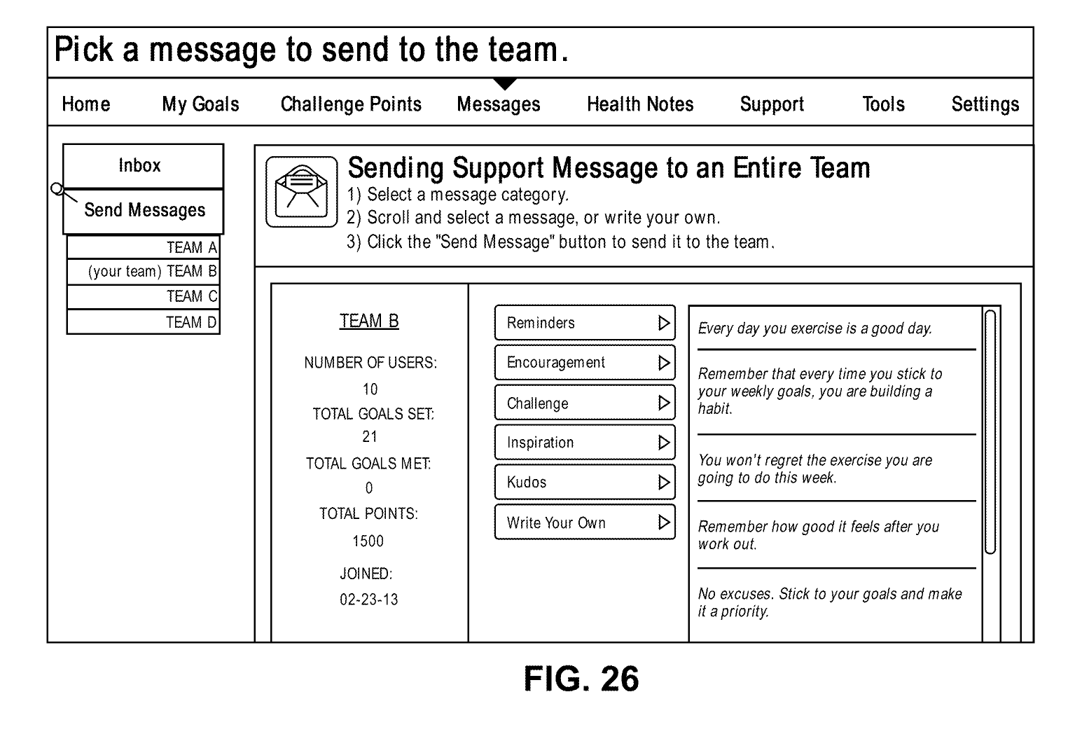

FIG. 24 depicts a flowchart of one embodiment of the Prevention Points process 370. A participant is enrolled in a computer-enabled intervention program. The participant engages with the program, for example by choosing a goal. During the enrollment process, the participant is assigned to a team (372). The team assignment may be made based on sequence of enrollment or a preference for a charity. The participant interacts with the program and earns points by positive behavior, which may include taking a quiz including information about food (374), staying with a diet or activity plan, or avoiding certain foods. The control program accesses the specification to determine whether this interaction should earn points, and how many (376). As each interaction is performed, several things happen. The total points are incremented on the user's home page, for the individual and for his team (380). A congratulatory message is shown on the screen. Points are added to the user's Team (in the Virtual Support Team Messaging Tool, described below in reference to FIG. 25 and FIG. 26).

Points may be redeemed in a number of ways, depending on the user's choice. For example, they may be redeemed for actual currency at a prescribed rate (e.g., 1 cent per point) (382). Alternatively, they may be contributed to charity (384). If the points are donated to charity, the specification defines either a single charity that may be relevant to the subject matter of the intervention (e.g., the American Diabetes Association) or the program may offer a choice of charities. In yet other embodiments, the points may be redeemed for lottery or raffle tickets. For example, if a participant earns 100 points in a week, he may be able to redeem the points for 100 lottery/raffle tickets. The participants may have to pay an entry fee (e.g., $10) to participate in the lottery/raffle drawing. That way, the proceeds to fund the prizes or prize money would come directly from the participants. Some portion of participants' fees may be raffled off periodically (e.g., weekly, biweekly, monthly).

### Virtual Support Team Messaging Tool

In some embodiments, the Virtual Support Messaging Tool provides social support to participants in a behavior change intervention. Participants are enrolled in virtual teams. Points accrued by individual members of a team accumulate for a team, and may earn rewards for the team. One of the components is the messaging system. The system of invention is unique in that it provides not only write-it-yourself messaging capability, but also pre-written messages that can be chosen and sent. A set of pre-written messages is created, and the category of each message is defined. For example, categories of messages might be “inspirational,” “challenge,” “reminders.” Within each category are a number of different quotations or other pre-written messages.

FIG. 25 depicts a flowchart of the behavior of the Virtual Support Messaging process 400. During participant's enrollment in the intervention program, participant is assigned to a team (402). The program encourages participant to send messages to team members, for example by using the internal messaging system (404). Program displays team members and message categories (406). When participant chooses a category, messages in that category are displayed (406). When participant chooses a message, program places that message in team member's inbox (408). FIG. 26 provides an example of one embodiment.

### Automated Coaching Tool

In face-to-face interventions, for example to increase physical activity, a human coach may answer questions and provide suggestions to assist the participant in overcoming barriers and achieving the goal.

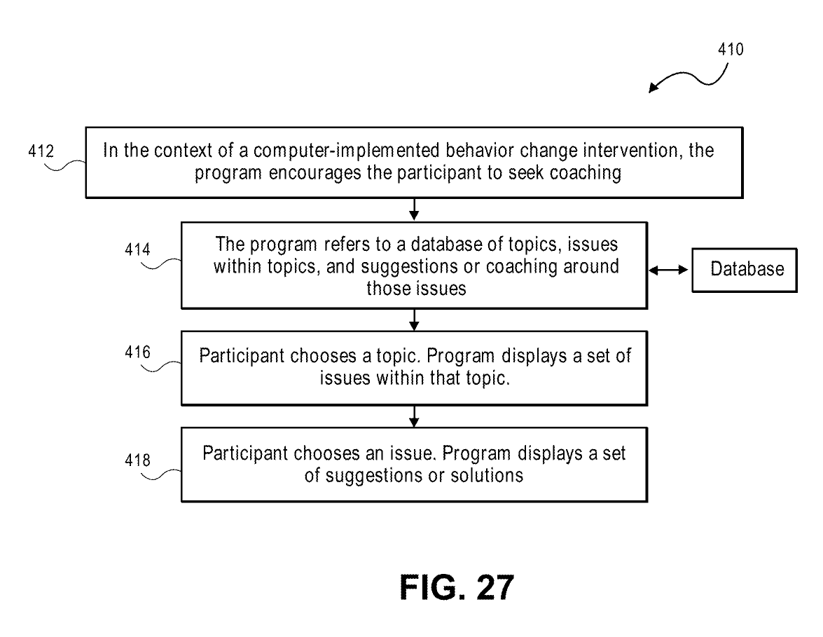

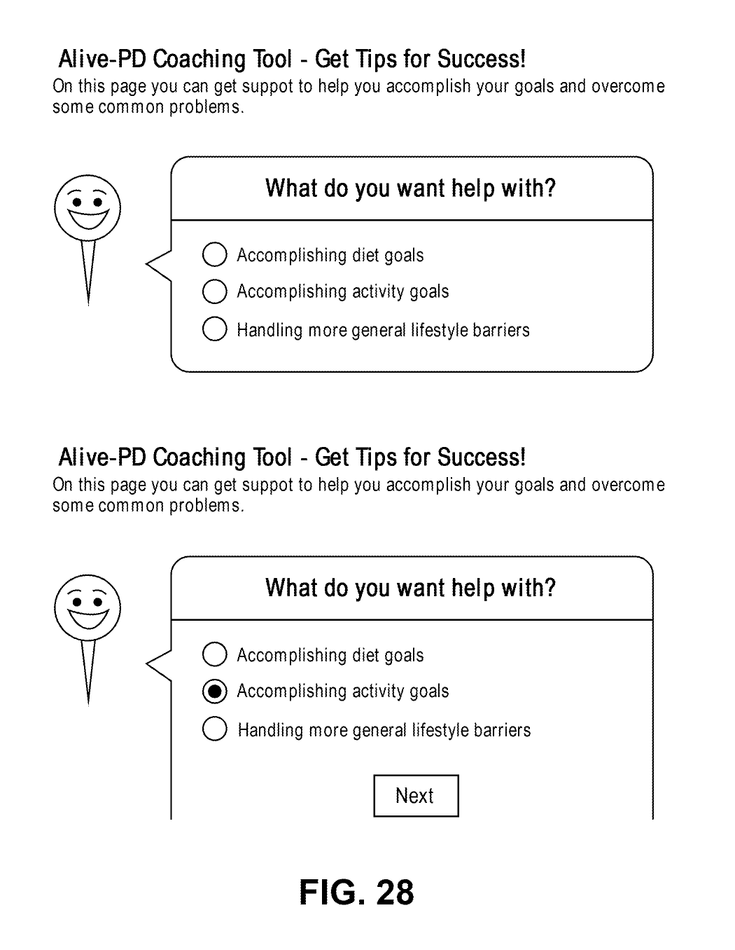

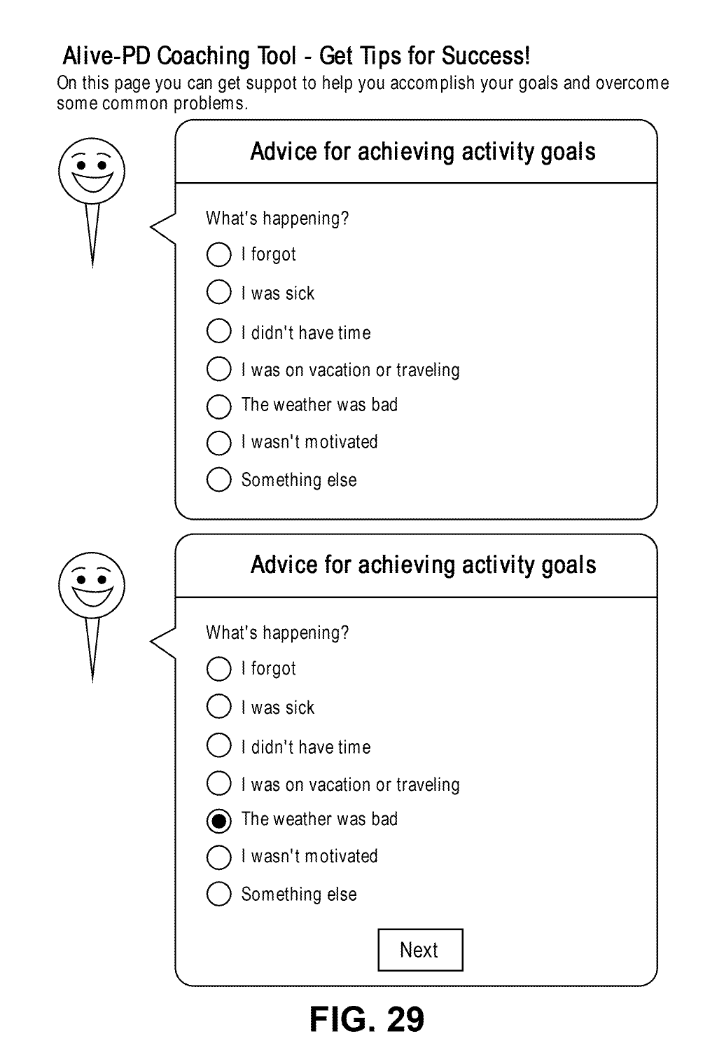

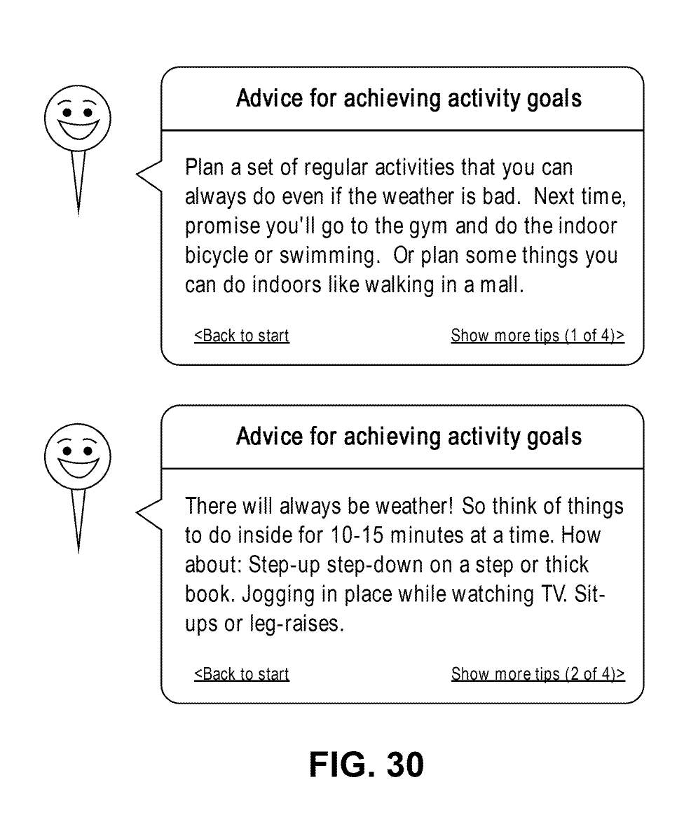

FIG. 27 depicts a flowchart of the functioning of one embodiment of the Automated Coaching process 410. In the context of a behavior change intervention program, the participant is encouraged to seek coaching (412) or otherwise presented with an opportunity to get coaching. The program accesses a database for topics, issues within topics, and suggestions or coaching around specific issues (414). A screen shot, such as the one shown in FIG. 28, may be used to communicate with the participant. In the context of a behavior-change program, a topic might be physical activity or dietary changes. The program refers to a database containing a series of different issues that may arise within each topic. For example, within the topic of physical activity, an issue might be “The weather was bad” (see example screen shot of FIG. 29). When a participant selects that topic and that issue (416), the program provides a set of suggestions (i.e., at least one suggestion) for handling that issue (418), for example as depicted in FIG. 30.

### Real-Time Reminder Tool

In behavior-change interventions, participants benefit from being reminded of the goals they have chosen to undertake, and to be stimulated to undertake them at specific pre-planned times. The Real-time Reminder Tool provides this assistance in a completely automated environment.

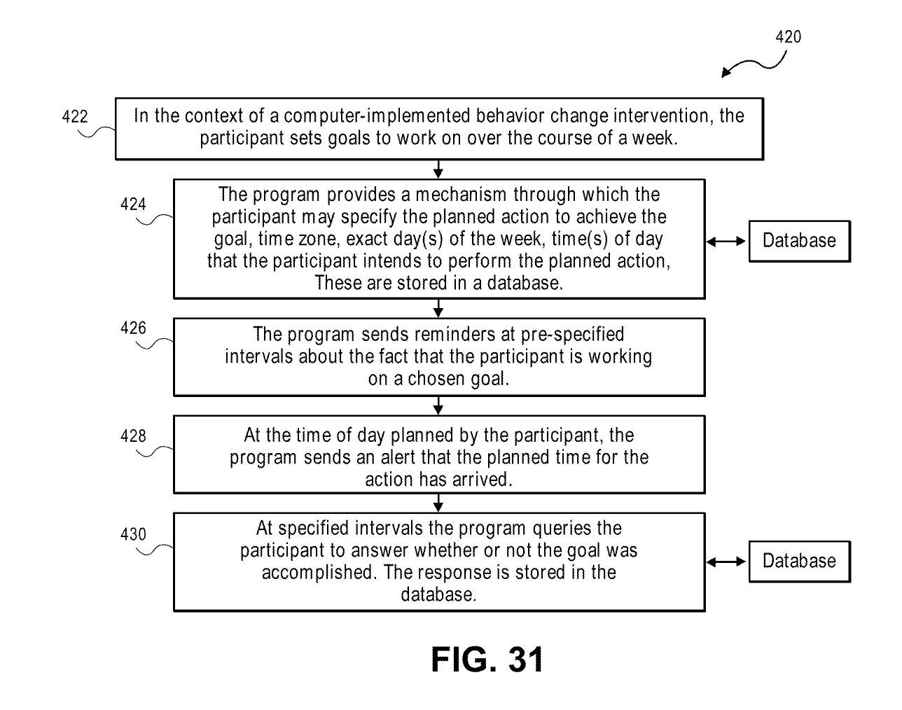

FIG. 31 depicts a flowchart of the functioning of one embodiment of this Real-time Reminder process 420. It is described in the context of a behavior-change program using a central server and program and a mobile device app. However, other implementations are possible, such as all-smartphone/smartwatch or central program plus text message reminding. The program provides a system through which the participant can choose a short-term goal or action to undertake (422), and to choose the exact day(s) and time(s) at which the action is to be undertaken (424). At intervals specified, the program reminds the participant of the goal he is focusing on (426). At the time of day specified by the participant, the program sends an alert that the planned time has arrived (428). This could be a device vibration, or a text message, or a phone call, or other means of real-time communication. At a later time, the program queries the respondent as to whether or not the planned goal was undertaken or achieved. This information is stored in the intervention program's database (430).

Various embodiments of the present disclosure may be implemented in or involve one or more computer systems. The computer system is not intended to suggest any limitation as to scope of use or functionality of described embodiments. The computer system includes at least one processing unit and memory. The processing unit executes computer-executable instructions and may be a real or a virtual processor. The computer system may include a multi-processing system which includes multiple processing units for executing computer-executable instructions to increase processing power. The memory may be volatile memory (e.g., registers, cache, random access memory (RAM)), non-volatile memory (e.g., read only memory (ROM), electrically erasable programmable read only memory (EEPROM), flash memory, etc.), or combination thereof. In an embodiment of the present disclosure, the memory may store software for implementing various embodiments of the present disclosure.

Further, the computer system may include components such as storage, one or more input computing devices, one or more output computing devices, and one or more communication connections. The storage may be removable or non-removable, and includes magnetic disks, magnetic tapes or cassettes, compact disc-read only memories (CD-ROMs), compact disc rewritables (CD-RWs), digital video discs (DVDs), or any other medium which may be used to store information and which may be accessed within the computer system. In various embodiments of the present disclosure, the storage may store instructions for the software implementing various embodiments of the present disclosure. The input computing device(s) may be a touch input computing device such as a keyboard, mouse, pen, trackball, touch screen, or game controller, a voice input computing device, a scanning computing device, a digital camera, or another computing device that provides input to the computer system. The output computing device(s) may be a display, printer, speaker, or another computing device that provides output from the computer system. The communication connection(s) enable communication over a communication medium to another computer system. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media includes wired or wireless techniques implemented with an electrical, optical, RF, infrared, acoustic, or other carrier. In addition, an interconnection mechanism such as a bus, controller, or network may interconnect the various components of the computer system. In various embodiments of the present disclosure, operating system software may provide an operating environment for software's executing in the computer system, and may coordinate activities of the components of the computer system.

Various embodiments of the inventive concept disclosed herein may be described in the general context of computer-readable media. Computer-readable media are any available media that may be accessed within a computer system. By way of example, and not limitation, within the computer system, computer-readable media include memory, storage, communication media, and combinations thereof.

Having described and illustrated the principles of the inventive concept with reference to described embodiments, it will be recognized that the described embodiments may be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of the described embodiments shown in software may be implemented in hardware and vice versa.

While the exemplary embodiments of the inventive concept are described and illustrated herein, it will be appreciated that they are merely illustrative. It should be understood that the invention can be practiced with modification and alteration within the spirit and scope of the disclosure. The description is not intended to be exhaustive or to limit the invention to the precise form disclosed.

What is claimed is:

1. A computer-implemented method of generating questions for a survey, the method comprising:
receiving user input regarding a relevant characteristic in response to a first question; and
using the user input and a default item to determine items to be included in the second question, wherein the items are associated with the relevant characteristic and are in a same item group as the default item.

2. The computer-implemented method of claim 1, wherein the relevant characteristic indicates types of foods eaten, items are specific food items, and an item group includes food items that share a nutritional commonality.

3. The computer-implemented method of claim 2 further comprising presenting no more than one food type on a screen at a given time, and determining the second question after receiving the user input in response to the first question.

4. The computer-implemented method of claim 1 further comprising:
calculating nutritional information in response to the user input; and
causing select nutritional information to be displayed on the same screen as the first question, wherein the nutritional information is automatically and dynamically updated with each added response.

5. The computer-implemented method of claim 1, wherein the survey is divided into a plurality of food categories, further comprising:
calculating nutritional information after all questions pertaining to one of the plurality of food categories are answered; and
automatically presenting a summary of the nutritional information before progressing to a next one of the food categories.

6. The computer-implemented method of claim 1 further comprising:
periodically generating a question about whether to review past responses; and
accepting changes to previously-received responses.

7. The computer-implemented method of claim 6 further comprising instantly recalculating total nutrient calculation to reflect the changes to the previously-received responses.

8. The computer-implemented method of claim 1 further comprising:
grouping questions into sets according to a predetermined criteria;
sorting the questions in a set according to their responses; and
accepting a re-sorting of the questions in the set.

9. The computer-implemented method of claim 8, wherein the predetermined criteria pertains to frequency of consumption.

10. The computer-implemented method of claim 8 further comprising treating a new response to be a midpoint between an original response and a response that reflects the re-sorting.

11. The computer-implemented method of claim 1 further comprising receiving further user input regarding details of the goal.

12. The computer-implemented method of claim 9 further comprising:
generating a plurality of options relating to the goal; and
receiving further user input comprising a selection from the plurality of options.

13. The computer-implemented method of claim 1, further comprising:
generating a combined question stating a plurality of food items;
receiving user inputs regarding frequency of consumption for the food items; and
calculating nutritional information by attributing a weight to each of the plurality of food items according to frequency of consumption.

14. The computer-implemented method of claim 1 further comprising generating an activity plan based on characteristics indicated by user inputs.

15. The computer-implemented method of claim 1 further comprising:
receiving a request to contact a person for support; and
generating a pre-prepared message to be sent to the person.

16. The computer-implemented method of claim 15 further comprising using an internal messaging system to exchange messages between a user and the person.

17. The computer-implemented method of claim 1, wherein the relevant characteristic indicates gender, age, and preferred activities, items are types of physical activity, and an item group includes activities that are similar in energy cost, intensity, or skill.

18. The computer-implemented method of claim 1 further comprising:
calculating activity-related information in response to the user input; and
causing select activity-related information to be displayed on the same screen as the first question, wherein the activity-related information is automatically and dynamically updated with each added response.

19. The computer-implemented method of changing a user's behavior, comprising:
assigning a user to a team; and
allowing the user to earn points for the team by making changes to one's diet and/or activities.

20. A computer-implemented method of claim 19 further comprising:
causing behavior-change categories to be displayed, the behavior-change categories including dietary change and physical activity change;
upon receiving a selection for one of the behavior-change categories, generating a list of possible issues pertaining to the behavior; and
upon receiving a selection from the list of possible issues, generating at least one suggestion for overcoming the selected issue.

21. The computer-implemented method of claim 19 further comprising generating questions for a survey by:
receiving user input regarding a relevant characteristic in response to a first question; and
using the user input and a default item to determine items to be included in the second question, wherein the items are associated with the relevant characteristic and are in a same item group as the default item.

22. A computer-implemented method of changing a user's behavior, comprising:
receiving responses to questions regarding a user's eating habits and physical activity level;
generating a recommendation to change the user's diet and/or physical activity level based on a goal;
rewarding points in response to either an indication that the recommended change has been made or by taking a quiz about nutrition and health; and
allowing points to be redeemed for one of actual currency and lottery/raffle tickets.
